(19) United States
(12) Patent Application Publication
(10) Pub. No.: US 2026/0289175 A1
(43) Pub. Date: Sep. 24, 2026

(54) SYSTEM

(71) Applicant: SoftBank Group Corp., Tokyo (JP)

(72) Inventor: Takuya YAMAGUCHI, Tokyo (JP)

(73) Assignee: SoftBank Group Corp., Tokyo (JP)

(21) Appl. No.: 19/564,685

(22) Filed: Mar. 12, 2026

(30) Foreign Application Priority Data
Mar. 19, 2025 (CN) 2025-044982

(51) Int. Cl. G06F 40/40; G06T 13/20; G06T 13/40; G10L 13/033

(52) U.S. Cl. CPC G06F 40/40; G06T 13/205; G06T 13/40; G10L 13/033

(57) ABSTRACT

A system includes a processor that is configured to collect data including at least a purchase history and a behavior pattern of a user and input, into a generative AI model, a prompt that instructs the generative AI model to analyze the collected data, analyze a response result of a virtual character and input, into the generative AI model, a prompt that instructs the generative AI model to analyze the response result and to optimize a sales promotion strategy based on a result of the analysis, and collect feedback from the user and input, into the generative AI model, a prompt that instructs the generative AI model to analyze the feedback and to use a result of the analysis for service improvement.

### CROSS-REFERENCE TO RELATED APPLICATION

This application is based on and claims priority under 35 USC 119 from Japanese Patent Application No. 2025-044982 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional customer service and sales promotion systems in retail environments, including systems using virtual characters or rule-based chatbots, are limited in their ability to flexibly analyze complex user data and to continuously improve service quality and sales strategies. In many cases, purchase histories, behavior patterns, and user feedback are stored but not effectively leveraged in real time, or are analyzed only through offline, manual, or rigid statistical methods. As a result, it is difficult to promptly derive high-resolution insights such as latent user preferences, effective dialogue patterns of virtual characters, or the true impact of service changes on customer satisfaction and sales. Furthermore, existing systems generally do not utilize generative AI models through appropriately designed prompts as a central engine for data analysis, strategy optimization, and service improvement, and therefore cannot fully benefit from the adaptive reasoning and content generation capabilities of such models. Accordingly, there is a need for a system that systematically collects user-related information and virtual character interaction results, generates prompts that instruct a generative AI model to perform multilayered analyses, and uses the analysis results to optimize sales promotion strategies and continuously improve services.

### SUMMARY

In order to solve the above-described problems, an aspect of the present invention provides a system comprising a processor, wherein the processor is configured to collect data including at least a purchase history and a behavior pattern of a user and input, into a generative AI model, a prompt that instructs the generative AI model to analyze the collected data. The processor is further configured to analyze a response result of a virtual character and input, into the generative AI model, a prompt that instructs the generative AI model to analyze the response result and to optimize a sales promotion strategy based on a result of the analysis. In addition, the processor is configured to collect feedback from the user and input, into the generative AI model, a prompt that instructs the generative AI model to analyze the feedback and to use a result of the analysis for service improvement. In one embodiment, the processor collects information including at least the purchase history and the behavior pattern of the user, generates the prompt that instructs the generative AI model to analyze the collected information, and inputs the generated prompt into the generative AI model. In another embodiment, the processor collects response result information of the virtual character, generates the prompt that instructs the generative AI model to analyze the collected response result information, inputs the generated prompt into the generative AI model to cause the generative AI model to perform the analysis, and optimizes the sales promotion strategy based on the result of the analysis. By orchestrating the collection of user-related data, virtual character interaction data, and user feedback, and by generating and supplying appropriate prompts to the generative AI model, the system enables dynamic and iterative optimization of sales promotion strategies and continuous improvement of customer service.

The term “system” refers to a combination of hardware and/or software components that cooperatively perform the functions described in the present specification and claims, including at least one processor and associated memory, interfaces, and programs.

The term “processor” refers to any hardware device or combination of devices capable of executing instructions, such as a central processing unit (CPU), a graphics processing unit (GPU), a digital signal processor (DSP), a microcontroller, an application-specific integrated circuit (ASIC), a field-programmable gate array (FPGA), or a combination thereof.

The term “user” refers to a person who receives services or products from the system, whose purchase history, behavior pattern, and feedback are collected and analyzed by the system. The term “purchase history” refers to information indicating records of products or services acquired by the user, including but not limited to items purchased, dates of purchase, prices, quantities, payment methods, contract terms, and related transactional details.

The term “behavior pattern” refers to information indicating actions or tendencies of the user in relation to services or products, including but not limited to browsing histories, interaction histories with virtual characters, store visit frequencies, response patterns to offers, and usage patterns of services.

The term “data” refers to electronic information acquired, stored, or processed by the system, including but not limited to purchase histories, behavior patterns, response results of virtual characters, and user feedback.

The term “information” refers to data that is structured, formatted, or interpreted for analysis by the system, including but not limited to user-related information, virtual character interaction information, and analysis results.

The term “virtual character” refers to a computer-generated agent or avatar, presented visually and/or audibly, that conducts interactions or responses to the user according to predetermined rules, models, or learned behavior.

The term “response result” refers to information indicating one or more outputs or behaviors of the virtual character in response to inputs from the user, including but not limited to generated utterances, suggested actions, recommended products, and interaction outcomes. The term “response result information” refers to recorded or structured data representing the response result of the virtual character, including the content of dialogues, timestamps, contextual metadata, and interaction-related attributes.

The term “generative AI model” refers to a machine learning model, such as a large language model, that generates outputs including text, instructions, or other content based on input prompts, and that is capable of performing analysis or reasoning on supplied data as instructed by such prompts.

The term “prompt” refers to information, typically in the form of text or structured input, that is provided to the generative AI model to instruct the generative AI model to perform a particular operation, such as analyzing collected data, inferring attributes, optimizing a strategy, or evaluating feedback.

The term “analyze” refers to the act of processing data using the generative AI model or other computational methods in order to extract patterns, relationships, metrics, inferences, or insights relevant to sales promotion or service improvement.

The term “sales promotion strategy” refers to a plan, rule set, or policy for promoting products or services to users, including but not limited to targeting rules, recommendation priorities, pricing tactics, campaign configurations, and communication approaches.

The term “optimize” refers to adjusting, selecting, or updating at least part of the sales promotion strategy based on analysis results, such that one or more performance indicators, including but not limited to sales volume, revenue, or customer satisfaction, are improved according to a predetermined criterion.

The term “feedback” refers to information provided by the user regarding experiences with the virtual character, services, or products, including but not limited to satisfaction scores, free-text comments, survey responses, complaints, and evaluations.

The term “service improvement” refers to modification, enhancement, or refinement of at least part of the services provided to the user, including but not limited to changes in dialogue flows, recommendation logic, interface behavior, or operational policies, based on analysis results obtained from the generative AI model.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

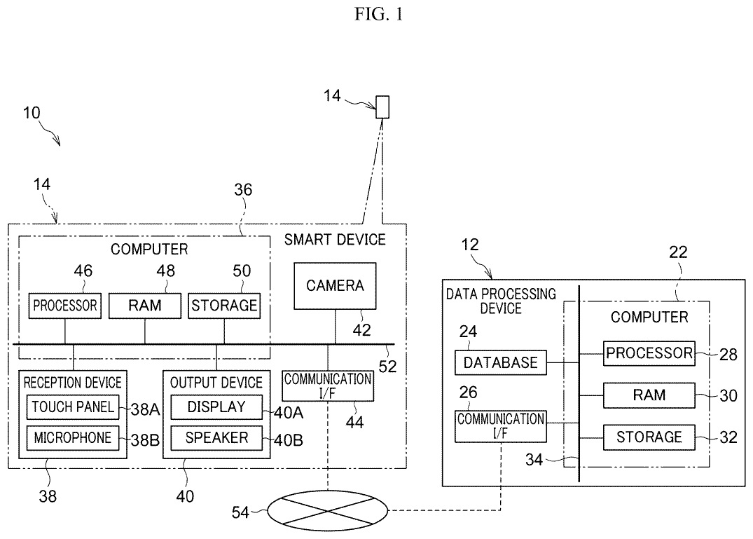

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

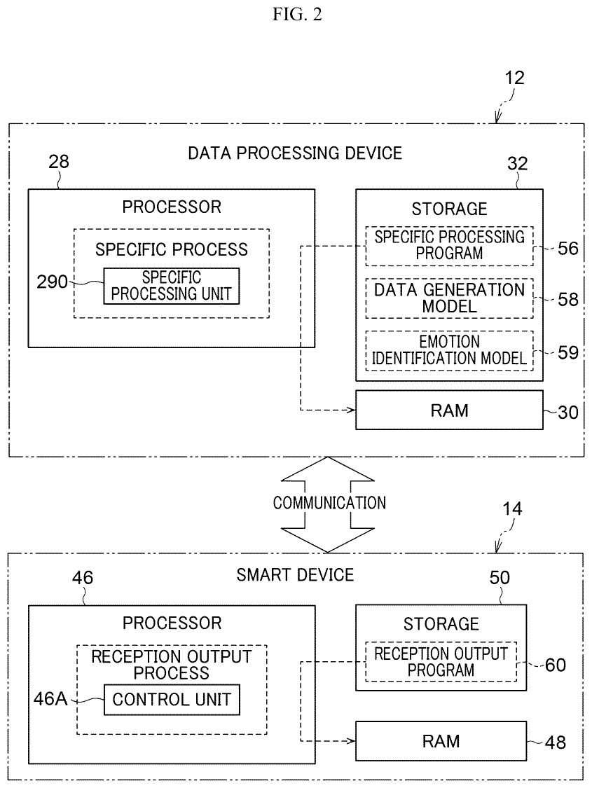

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional virtual customer-service systems that employ programmed dialogue trees or static rule-based engines suffer from several technical limitations when deployed at scale on general-purpose computing hardware. First, such systems are typically configured to apply a fixed dialogue flow to all users, regardless of heterogeneous user attributes derived from large volumes of purchase history data and behavior history data. As a result, even when a server stores rich interaction logs and sales results, the system cannot effectively transform these data into adaptive control of dialogue generation in real time. From a computer-technology perspective, this leads to suboptimal utilization of storage and processing resources, because the server merely records interaction data as passive logs without feeding them back into the dialogue-generation pipeline in a structured way.

Second, when a generative AI model is introduced as a dialogue engine, existing systems often invoke the model with ad hoc or manually-crafted prompts that are not systematically linked to machine-readable user attribute information, interaction history information, sales result information, or user feedback information. This lack of structured prompt generation causes technical problems in the computing system: the server must perform repeated trial-and-error calls to the model, network bandwidth is inefficiently consumed, and CPU and memory resources are wasted due to redundant post-processing of unsuitable outputs. Furthermore, the generative AI model may return inconsistent or non-actionable responses, because the input context does not reflect a unified representation of user state and system objectives.

Third, conventional systems do not provide a coherent mechanism by which a server can dynamically reconfigure virtual interactive agents (including their persona, voice characteristics, and dialogue scripts) in response to user requests and ongoing evaluation of interaction quality and sales performance. In many implementations, any change of the virtual interactive agent's appearance or speaking style requires manual configuration or offline content creation, which interrupts service and increases computational overhead for content management. Consequently, the server cannot efficiently orchestrate model calls and content updates in a way that preserves conversational continuity while minimizing round trips and processing time.

Fourth, known architectures generally fail to exploit the generative AI model itself as a programmable component for continuously improving internal control artifacts, such as prompt templates, recommendation policies, and sales-promotion strategies, based on aggregated evaluation information. Without such feedback, the server treats the generative AI model as a black-box text generator, instead of as a configurable computational module whose behavior can be iteratively optimized by machine-generated prompt refinement. This prevents the computing system from achieving long-term optimization of model usage patterns and limits the scalability and robustness of the overall service.

Accordingly, there is a need for an improved computer-implemented system in which a server automatically generates and refines structured prompt sentences for a generative AI model, based on integrated user attribute information, interaction history information, sales result information, and user feedback information; dynamically reconstructs virtual interactive agents and their dialogue content in response to real-time inputs; and continuously optimizes the generative AI model's usage mode and associated sales-promotion strategies. Such a system should technically improve how the server manages dialogue context, orchestrates generative AI calls, and controls output formats, thereby enhancing efficiency, consistency, and adaptability of the underlying computer resources.

The specific processing by the specific processing unit 290 of the data processing device 12 in Example 1 is realized by the following means.

The present invention provides a server comprising a processor configured to obtain, from a storage device, purchase history information and behavior history information associated with a user identification, analyze the purchase history information and the behavior history information by statistical processing and feature extraction processing to generate user attribute information, generate a prompt sentence including the user attribute information, and input the prompt sentence to a generative artificial intelligence model; to obtain response information from the generative artificial intelligence model, structure the response information as customer-service content of a virtual interactive agent, combine the customer-service content with display control information including appearance information and audio information of the virtual interactive agent, and transmit the display control information to a terminal device; to store user input information obtained from the terminal device and interaction history information of the virtual interactive agent, evaluate interaction quality and sales performance of the virtual interactive agent based on the interaction history information and sales result information, generate a prompt sentence including an evaluation result, input the prompt sentence to the generative artificial intelligence model, and update a sales promotion strategy and the customer-service content of the virtual interactive agent based on output information obtained from the generative artificial intelligence model; to generate a prompt sentence that inputs feedback information of a user, obtained from the terminal device, to the generative artificial intelligence model, and change, based on an analysis result obtained from the generative artificial intelligence model, at least one of the appearance information, the audio information, and a dialogue policy of the virtual interactive agent to improve a service content; to respond, in accordance with user input information including a change request of the virtual interactive agent obtained from the terminal device, by inputting a prompt sentence including the user attribute information and the change request to the generative artificial intelligence model, dynamically reconstruct a persona, a speaker characteristic, and dialogue text of the virtual interactive agent based on output information obtained from the generative artificial intelligence model, and transmit reconstructed display control information to the terminal device; and to generate, for the prompt sentence to be input to the generative artificial intelligence model, control information specifying a plurality of output formats including dialogue text, recommended product information, and emotional expression information, by combining the user attribute information, the interaction history information, the sales result information, and the feedback information of the user. This enables the server to improve computer functionality by automatically transforming stored multi-dimensional interaction data into structured prompt sentences that condition the generative artificial intelligence model, reduce redundant model invocations and post-processing by constraining output formats at the prompt level, dynamically reconfigure virtual interactive agents in real time without manual content editing, and continuously optimize internal prompt templates and sales-promotion control logic, thereby enhancing processing efficiency, response consistency, and adaptability of the overall computer-implemented customer-service system.

The term “processor” refers to a hardware-based computation unit, such as a central processing unit or an equivalent processing circuitry, that executes instructions to perform data acquisition, analysis, control, and communication operations within the system.

The term “storage device” refers to a hardware-based data retention component, such as a magnetic disk drive, a solid-state drive, or a semiconductor memory, that stores purchase history information, behavior history information, interaction history information, sales result information, and user feedback information.

The term “user identification information” refers to information that uniquely or quasi-uniquely identifies a user within the system, such as an identifier, an account reference, or a session token, and that is used to retrieve associated data from the storage device.

The term “purchase history information” refers to data representing past transaction records of a user, including at least item identifiers, transaction times, transaction quantities, and transaction prices, stored in association with the user identification information.

The term “behavior history information” refers to data indicating past behavior patterns of a user in relation to a service, including at least browsing records, selection operations, interaction events, and temporal patterns of access, stored in association with the user identification information.

The term “statistical processing” refers to a computational operation applied to purchase history information and behavior history information to calculate numerical characteristics such as frequencies, averages, distributions, and trends that summarize the underlying data. The term “feature extraction processing” refers to a computational operation that derives structured feature values or indicators, such as preference scores, segment labels, or behavior intensities, from raw purchase history information and behavior history information for use in subsequent analysis or model input.

The term “user attribute information” refers to structured information representing characteristics of a user, including at least one of preference indicators, segment classifications, spending tendencies, or interaction tendencies, generated by applying statistical processing and feature extraction processing to purchase history information and behavior history information.

The term “prompt sentence” refers to a machine-readable instruction content expressed in natural language or a structured format, generated by the processor and supplied as input to a generative artificial intelligence model to condition or control the content, style, or structure of output information produced by the generative artificial intelligence model.

The term “generative artificial intelligence model” refers to a parameterized computational model, implemented by machine learning or deep learning techniques, that receives a prompt sentence as input and generates output information such as text, control tokens, or structured data in accordance with learned patterns.

The term “response information” refers to data generated by the generative artificial intelligence model in response to a prompt sentence, including at least dialogue content, recommendation content, control directives, or other information intended for use in customer-service processing.

The term “virtual interactive agent” refers to a computer-generated entity, represented by at least appearance information and audio information, that conducts interactive communication with a user by presenting dialogue content, gestures, or other expressions through a terminal device.

The term “customer-service content” refers to information that defines behavior of the virtual interactive agent toward a user, including at least dialogue text, recommended items, explanations, questions, and guidance statements structured for interactive presentation.

The term “display control information” refers to information that controls presentation of the virtual interactive agent and associated content on the terminal device, including at least appearance information, audio information, timing information, and animation-related parameters.

The term “appearance information” refers to data describing a visual representation of the virtual interactive agent, including at least character type, facial features, clothing style, color scheme, or graphical resources used for rendering.

The term “audio information” refers to data describing or representing sound output associated with the virtual interactive agent, including at least speech content, voice characteristics, prosody parameters, and audio playback control information.

The term “terminal device” refers to an information processing apparatus, such as a mobile device, a stationary display device, or a computing terminal, equipped with at least a display, an audio output component, an input interface, and a communication interface, and configured to communicate with the server.

The term “user input information” refers to information representing actions or expressions of a user captured by the terminal device, including at least touch inputs, button operations, voice inputs, text inputs, or explicit requests for changes.

The term “interaction history information” refers to data representing past exchanges between the virtual interactive agent and a user, including at least presented dialogue content, user responses, timing of interactions, and system-selected actions.

The term “sales result information” refers to data indicating outcomes of commercial activities associated with interactions, including at least purchase completion indicators, purchased item identifiers, quantities, prices, and related performance metrics.

The term “interaction quality” refers to an evaluation result indicating how effectively the virtual interactive agent has interacted with the user, based on at least user engagement indicators, feedback information, response appropriateness, or conversation continuity.

The term “sales performance” refers to an evaluation result indicating effectiveness of the virtual interactive agent in contributing to commercial outcomes, based on at least conversion rate, revenue amount, or number of recommended items accepted by users.

The term “evaluation result” refers to structured information representing assessment outcomes of interaction quality and sales performance, derived from interaction history information, sales result information, or related metrics.

The term “feedback information” refers to information indicating user reactions or evaluations regarding the service, including at least explicit ratings, comments, satisfaction indicators, or implicit behavior signals such as continued use or early termination.

The term “dialogue policy” refers to a set of rules or parameters that govern how the virtual interactive agent selects dialogue acts, tone, and content sequencing in response to user input and system objectives.

The term “change request” refers to user input information that instructs modification of characteristics of the virtual interactive agent, including at least persona type, appearance style, speaking style, or other presentation attributes.

The term “persona” refers to a conceptual characterization of the virtual interactive agent, including at least personality traits, role description, manner of speaking, and interaction style, used to guide dialogue generation and presentation.

The term “speaker characteristic” refers to a property of the virtual interactive agent's voice, including at least pitch, timbre, speaking speed, accent, and formality level.

The term “dialogue text” refers to text data representing utterances to be spoken or displayed by the virtual interactive agent during interaction with the user.

The term “reconstructed display control information” refers to display control information that has been updated or newly generated based on output information from the generative artificial intelligence model in response to a change request or other updated inputs.

The term “control information” refers to data included in or associated with a prompt sentence that specifies desired properties of output information from the generative artificial intelligence model, including at least output format types, length constraints, style constraints, or inclusion of particular information elements.

The term “output format” refers to a structure or type of data requested from the generative artificial intelligence model, such as continuous dialogue text, bullet-point explanations, structured recommendation lists, or annotated content with emotion labels.

The term “recommended product information” refers to information about items or services suggested to a user, including at least item identifiers, descriptive text, prices, and key selling points generated or selected by the system.

The term “emotional expression information” refers to data specifying emotional states or expressions to be associated with dialogue content of the virtual interactive agent, including at least emotion labels, intensity indicators, and corresponding animation or prosody parameters. The term “question-and-answer processing” refers to a sequence of operations in which a user question is received, transformed into a prompt sentence for the generative artificial intelligence model, and the resulting answer is converted into output by the virtual interactive agent.

The term “speech recognition processing” refers to a computational process that converts voice input information into character-based text information using an acoustic model, a language model, or equivalent recognition algorithm.

The term “character information” refers to text-based data obtained by converting voice input information through speech recognition processing, and used as an input element for generating a prompt sentence or for other internal processing.

The term “evaluation information” refers to aggregated or summarized data that combines interaction history information, sales result information, and feedback information to provide a basis for assessing system performance or for generating improvement plans.

The term “dialogue script” refers to a sequence or template of dialogue text, optionally with structural markers or branching logic, defining how the virtual interactive agent should converse with a user under specified conditions.

The term “sales promotion measure” refers to a strategy or action plan for encouraging purchases, including at least recommendation rules, discount presentation patterns, cross-selling tactics, and timing of offers.

The term “improvement plan” refers to content generated by the generative artificial intelligence model that proposes modifications to dialogue scripts, sales promotion measures, or related control artifacts, based on evaluation information.

The term “template of the prompt sentence” refers to a reusable structural pattern or format for constructing prompt sentences, including placeholders for user attribute information, evaluation information, and control information.

The term “recommendation policy” refers to a rule set or parameter set that governs selection, ranking, or presentation of recommended items or services to users, taking into account user attribute information, system objectives, and evaluation information.

The term “usage mode of the generative artificial intelligence model” refers to a configuration or pattern of how the generative artificial intelligence model is invoked, including at least prompt design, call frequency, output format specification, and integration with other system components.

The term “sales promotion strategy” refers to an overall plan or configuration for using the virtual interactive agent and the generative artificial intelligence model to achieve commercial objectives, including coordinated use of recommendation policies, dialogue policies, and promotion measures.

Server executes an embodiment of the invention as a network-accessible backend system including at least one processor, a main memory, a persistent storage device, and a communication interface. Server executes an operating system and an application program written, for example, in a general-purpose programming language that supports numerical computation and data processing. Server connects, via a network, to one or more terminal devices. Terminal executes an application, such as a native application or a browser-based application, and includes at least a display, an audio output device, an input interface, and a communication interface. User operates terminal and interacts with a virtual interactive agent presented on terminal.

Server stores, in persistent storage, multiple types of data structures. Server stores purchase history information in a relational table including at least a user identifier field, an item identifier field, a transaction timestamp field, a quantity field, and a price field. Server stores behavior history information in a separate relational table including at least a user identifier field, an event type field, a content identifier field, a timestamp field, and a dwell-time field. Server stores interaction history information in another table including at least a session identifier field, a user identifier field, a system-utterance field, a user-utterance field, an utterance timestamp field, and a result flag field. Server stores sales result information that links interaction history information with concrete transaction outcomes by including at least a session identifier field, a purchased item identifier field, a quantity field, a revenue field, and a promotion identifier field. Server stores user feedback information in a separate table including at least a user identifier field, a session identifier field, a rating value field, a free-text comment field, and a feedback timestamp field.

Server loads these tables into memory as columnar data structures. In one embodiment, server uses a numerical computation library such as a matrix processing library to implement feature extraction and statistical processing. Server performs operations such as grouping by user identifier, summing quantities, computing frequencies of item categories, computing average spending per category, computing inter-purchase intervals by subtracting sequential timestamps, and computing distribution metrics such as variance and percentiles. Server normalizes numerical features to a standardized range and encodes categorical features, such as item categories and event types, as numerical indices or embedding vectors.

Server constructs user attribute information as a structured record composed of several feature fields. For example, server includes a sports-preference score computed as a normalized frequency of purchases in a sports category, a budget-level indicator computed from an average price and a price variance, a responsiveness indicator derived from a ratio of replied prompts to total prompts in interaction history information, and a promotion-sensitivity indicator derived from a difference in conversion rates between interactions with promotions and interactions without promotions. Server stores this user attribute information in a user-profile data structure in memory and, optionally, in persistent storage.

Server inputs user attribute information into a generative AI model using a prompt sentence. In one embodiment, server integrates a transformer-based neural network as the generative AI model. The transformer includes a plurality of self-attention layers, feed-forward layers, layer-normalization units, and learned embedding matrices. The generative AI model is trained in advance on large-scale text data and further fine-tuned on domain-specific conversation data comprising virtual customer-service dialogues. During fine-tuning, server (or a separate training system) minimizes a cross-entropy loss function between predicted tokens and ground truth tokens, and updates model parameters by gradient-based optimization such as stochastic gradient descent or an adaptive learning-rate algorithm. The training process uses batch normalization, dropout, or similar regularization techniques to improve generalization and stability.

Server configures the generative AI model to accept, as input, a tokenized prompt sentence comprising both natural-language instructions and serialized user attribute information. For instance, server constructs a prompt sentence such as:
“User attributes: prefers sports goods, mid-price range, often buys running shoes every six months.
Task: As a virtual in-store assistant, generate a personalized recommendation and dialogue script for up to three products. Use a friendly and concise tone suitable for spoken interaction.”

Server tokenizes this prompt sentence and encodes it into embedding vectors that serve as input to the transformer layers. The model processes the embeddings through stacked attention layers that compute attention weights over previous tokens according to learned query, key, and value matrices. The model outputs a sequence of tokens that server decodes into response information representing customer-service content, including product recommendations, explanation sentences, and follow-up questions. Because server uses a single, structured prompt sentence that integrates user attribute information and explicit control instructions, server reduces the need for multiple trial-and-error invocations and decreases network traffic and computation load.

Server constructs additional prompt sentences for dynamic reconfiguration of the virtual interactive agent. For example, when user issues a change request, server constructs a prompt sentence such as:
“Rewrite the following sales dialogue so that it is spoken by a calm professional advisor avatar.
Maintain all product facts and use polite, respectful language.
Original dialogue: [previous script text].”

Server supplies this prompt sentence to the same generative AI model. The model processes the prompt and produces revised dialogue text that adheres to the persona constraints. Server thereby dynamically reconstructs the persona, speaker characteristics, and dialogue text of the virtual interactive agent without generating a new script manually or restarting the session. This dynamic reconstruction is not a mere automation of human editing, because server enforces machine-readable persona parameters and uses them as constraints within the prompt sentence, and the generative AI model applies its learned linguistic structure and attention mechanisms to propagate persona changes consistently across multiple utterances.

Server further generates prompt sentences for question-and-answer processing. When user asks a question about a product, server retrieves corresponding product specification data from the storage device and constructs a prompt sentence such as:
“You are a virtual shop assistant.
Product specification: [specification text].
User question: ‘How durable are these shoes if I run three times a week?’
Task: Answer in simple language in about three sentences, focusing on durability and care tips, for use as spoken dialogue by a virtual character.”

Server inputs this prompt sentence into the generative AI model and obtains response information optimized for spoken delivery. Because server explicitly encodes constraints such as length, focus, and usage context into the prompt sentence, server controls the output distribution of the generative AI model and reduces post-processing complexity.

Server additionally uses generative AI model output to improve internal control artifacts. Server aggregates evaluation information by computing, for example, a conversion rate per persona, an average session length, a distribution of user ratings, and a rejection rate of recommended items. Server summarizes these metrics into textual evaluation information and constructs a prompt sentence such as:
“Based on the following performance summary, propose three improvements to the dialogue script and sales promotion strategy for the virtual assistant.

### Performance Summary:

Persona A: conversion rate 8%, user rating 3.2/5, frequent early session termination.
Persona B: conversion rate 15%, user rating 4.1/5, stable engagement.
Common issues: users often ask about return policy and size fit.
Task: Suggest specific changes in greeting, recommendation order, and follow-up questions.”

Server feeds this prompt sentence to the generative AI model and obtains improvement plans for dialogue scripts and sales promotion measures. Server parses the generated text and updates prompt templates and recommendation policies stored in the system. By doing this, server uses the generative AI model not only as a dialogue generator but also as a computational module for prompt-template optimization. Server thereby improves the way prompts are constructed over time, which in turn improves consistency and quality of subsequent outputs and reduces required manual tuning.

Terminal operates as a client-side system that receives display control information from server. Terminal decodes appearance information of the virtual interactive agent and renders corresponding graphical assets using a graphics rendering engine such as a general-purpose 2D or 3D graphics library. Terminal maps dialogue text to animation control parameters, including lip-sync timing and facial expression cues, and schedules these animations in synchronization with audio information. Terminal invokes a text-to-speech engine, such as a neural-network-based speech synthesizer, that converts dialogue text into audio samples. This speech synthesizer uses an acoustic model and a vocoder model to generate waveform data. Terminal sends the waveform data to an audio driver for playback on speakers. Because server supplies structured display control information that already encodes persona, emotional expression, and timing, terminal can execute deterministic rendering and audio playback without performing heavy reasoning itself, which reduces terminal-side computational load and latency.

Terminal captures user input information via sensors and user interface components. When user speaks to the virtual interactive agent, terminal captures voice input through a microphone and sends raw audio or compressed audio frames to server or to a speech recognition engine. The speech recognition engine applies, for example, a deep neural network comprising convolutional layers and recurrent layers to predict character sequences from acoustic features such as Mel-frequency cepstral coefficients. The engine uses a language model to refine predicted sequences and outputs character information representing the recognized question or command. Terminal or server uses this character information as part of the user input information used for subsequent prompt-sentence construction.

Server applies non-trivial rules to map user input information into prompt sentences. For example, server distinguishes between a “change character” request and a product inquiry based on keyword detection and intent classification. Server uses a classifier, such as a shallow neural network or a support vector machine, trained on labeled utterance-intent pairs. Server includes classification results in the prompt sentence in a structured form such as “Intent: change_avatar” or “Intent: ask_product_detail,” which guides the generative AI model to select an appropriate dialogue pattern and output format. This explicit intent encoding improves efficiency by avoiding redundant model calls with ambiguous instructions and contributes to a reduction of error rate in downstream processing.

Server architecture includes multiple modules that are interconnected in a defined data flow. A data acquisition module retrieves purchase history information and behavior history information from the storage device. A feature computation module executes statistical processing and feature extraction. A profile management module stores and updates user attribute information. A prompt generation module assembles prompt sentences using templates, user attribute information, evaluation information, and control information specifying output formats. A generative inference module communicates with the generative AI model, handles tokenization, invocations, and detokenization of output tokens. A content post-processing module validates and structures response information, checks consistency against product data, and attaches metadata such as emotional expression information. A rendering-control module constructs display control information for terminal. An evaluation module monitors interaction history information and sales result information and generates evaluation information.

Server improves computer technology by changing the way the generative AI model is used. Instead of sending only raw user text as input, server forms prompt sentences that combine multiple layers of system state (user attribute information, interaction history information, and evaluation information) and control directives (output format specification and persona parameters). This architecture reduces the number of interactions between server and generative AI model by producing more targeted and constrained outputs in a single call. As a result, server decreases CPU and GPU usage on the model host, lowers network traffic between server and the model endpoint, and shortens end-to-end response latency perceived by user. Furthermore, because server uses structured control information in prompt sentences and maintains internal representations of persona and recommendation policy, server reduces variability in model outputs and limits the need for additional heuristic post-processing, thereby improving accuracy and reproducibility of the system.

Server also improves data management by transforming unstructured logs into structured user attribute information and evaluation information that are explicitly consumed by the prompt generation module. This closed-loop design causes a technical effect: each new interaction contributes to feature statistics and evaluation metrics that shape future prompts, thus gradually optimizing both the generative AI model usage pattern and the data flow in the system. Server thereby reduces redundancy in data storage and computation, since only selected feature aggregates and evaluation summaries are required for prompt construction, not raw logs for every decision.

In an alternative embodiment, server hosts the generative AI model locally on the same hardware. In this case, server loads model parameters into GPU memory and performs inference using optimized matrix-multiplication kernels. Server can adjust precision (for example, by using half-precision floating point or integer quantization) to reduce memory footprint and inference time. Server can further adapt decoding parameters such as temperature and maximum token length dynamically based on evaluation information, for instance, lowering temperature for high-stakes transactional utterances to improve determinism and lowering maximum token length when network congestion is detected to reduce bandwidth usage. These algorithmic controls produce a measurable improvement in throughput and latency of the computer system compared with conventional use of generative models with fixed parameters.

In another embodiment, server employs multiple generative AI models specialized for different tasks, such as one model for generating persuasive recommendations and another for generating clarification questions. Server selects which model to invoke based on intent classification results and user attribute information. Server also uses a rule-based fallback mechanism; if a generative model call times out or produces content that fails validation (for example, mentions an unavailable item), server switches to a template-based response that relies on precomputed snippets. This hybrid scheme enhances robustness of the system while preserving efficiency gains from model-based generation.

In use, user operates terminal in a physical store or a remote environment. Terminal displays the virtual interactive agent and plays audio guidance generated according to the methods described. User issues commands such as “Show me new running shoes” or “Change the character to a younger style.” Server processes these inputs through the pipeline of feature extraction, prompt generation, generative inference, and content structuring. Terminal presents updated dialogue content and avatar configuration in near real time. Because server continuously evaluates interaction quality and sales performance and updates prompt templates and recommendation policies accordingly, the system adapts to changing conditions without human reprogramming, and does so using technical mechanisms—structured prompts, machine-learned models, and optimized data flows—that improve the function of the underlying computing system beyond simple automation of human tasks.

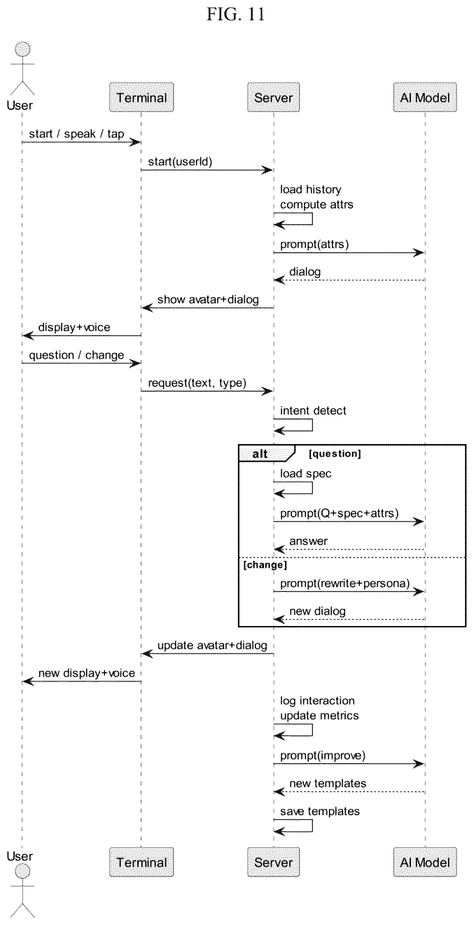

The following describes the processing flow using FIG. 11.

### Step 1:

Server receives a session start request from terminal including user identification information and a request type.

Server uses the request payload as input and parses fields such as user ID, device type, and initial intent.

Server validates the user ID format, associates it with an internal session identifier, and writes a log entry to persistent storage as output, including timestamp, session ID, and initial intent.

### Step 2:

Server queries a storage device for purchase history information and behavior history information corresponding to the user ID.

Server uses the user ID as input and executes database queries that fetch rows from purchase-history tables and behavior-history tables.

Server aggregates the returned rows into in-memory columnar structures as output, containing item identifiers, timestamps, prices, event types, and dwell times.

### Step 3:

Server computes numerical features and categorical indicators from the purchase history information and behavior history information.

Server uses the columnar data as input and applies statistical processing such as grouping by item category, summing quantities, computing average spending, and calculating inter-purchase intervals using timestamp differences.

Server normalizes the resulting feature values, encodes categorical variables as numerical indices, and outputs a user attribute vector and intermediate feature maps.

### Step 4:

Server generates user attribute information as a structured profile based on the computed features.

Server uses the user attribute vector and feature maps as input and applies rule-based thresholds or a trained classifier to assign segment labels, such as “sports-oriented,” “mid-price,” or “promotion-sensitive.”

Server outputs user attribute information as a profile object that includes segment labels and numerical preference scores and stores this profile in a profile repository.

### Step 5:

Server constructs an initial prompt sentence for the generative AI model to generate customer-service content.

Server uses user attribute information, session intent, and system configuration parameters as input and fills a textual template with these values.

Server outputs a prompt sentence in natural language, for example:
“User attributes: prefers sports goods, mid-price range, often buys running shoes every six months.
Task: As a virtual in-store assistant, generate a personalized recommendation and dialogue script for up to three products. Use a friendly and concise tone suitable for spoken interaction.”

### Step 6:

Server invokes the generative AI model with the constructed prompt sentence.

Server uses the prompt sentence and model parameters (model name, temperature, maximum token length) as input and sends an API request or function call to the model host.

Server receives generated tokens as output, decodes them into text, and obtains response information that includes dialogue text, recommendation descriptions, and suggested follow-up questions.

### Step 7:

Server validates and structures the response information into customer-service content for a virtual interactive agent.

Server uses the generated text as input and parses it into sections such as greeting, main recommendation, explanation, and closing, optionally using delimiters or pattern matching. Server cross-checks product references against product data tables, removes or corrects invalid entries, and outputs structured customer-service content with associated product IDs and metadata.

### Step 8:

Server generates display control information for terminal based on customer-service content and stored persona configuration.

Server uses customer-service content, persona parameters (voice type, emotion style, speaking speed), and appearance configuration as input.

Server maps dialogue segments to animation cues, assigns emotional expression tags, builds a timeline of utterances, and outputs display control information that includes avatar appearance information, dialogue text, and timing metadata.

### Step 9:

Server transmits the display control information to terminal.

Server uses the display control information and session identifier as input and packages them into a network message.

Server sends the message through a communication interface, and outputs a confirmed delivery status after receiving an acknowledgment from terminal.

### Step 10:

Terminal receives and parses the display control information from server.

Terminal uses the incoming message as input and decodes fields such as avatar configuration, dialogue text, and timing instructions.

Terminal outputs internal data structures for rendering, including loaded avatar assets, a dialogue queue, and animation schedules.

### Step 11:

Terminal renders the virtual interactive agent on the display and plays corresponding audio. Terminal uses the avatar configuration and dialogue text as input and calls a graphics engine to draw the avatar with specified appearance parameters.

Terminal invokes a text-to-speech engine with dialogue sentences and voice parameters, generates audio samples, synchronizes lip movements and facial expressions with audio timing, and outputs video frames on the display and sound through speakers.

### Step 12:

User views and listens to the virtual interactive agent and provides input.

User uses visual and auditory perception as input and performs actions such as speaking, touching a screen element, or pressing a button.

User outputs user input information in the form of speech commands (e.g., “Show me more colors” or “Change character”), taps on product icons, or submits text queries via an input field.

### Step 13:

Terminal captures user input information and converts it into machine-readable form.

Terminal uses raw interactions (touch coordinates, key events, and microphone audio signals) as input and classifies the interaction type.

Terminal converts speech audio into character information using speech recognition, maps touch coordinates to user interface elements, and outputs a structured request payload including recognized text, selected item identifiers, and inferred local intent.

### Step 14:

Terminal transmits the structured request payload to server.

Terminal uses the structured request payload and session identifier as input and encapsulates them in a network request.

Terminal sends the request to server and outputs a transmission status and any local logging information.

### Step 15:

Server interprets the structured request payload and determines a processing mode.

Server uses recognized text, local intent hints, and current conversation context as input and applies an intent classifier or rule set.

Server outputs a classification result indicating whether the request is a product inquiry, a character-change request, a purchase-related question, or another interaction type.

### Step 16:

Server generates a prompt sentence for question-and-answer processing when the request is identified as a question.

Server uses recognized question text, relevant product specification data retrieved from the storage device, and user attribute information as input.

Server constructs a prompt sentence such as:
“You are a virtual shop assistant.
Product specification: [specification text].
User question: ‘How durable are these shoes if I run three times a week?’
Task: Answer in simple language in about three sentences, focusing on durability and care tips, for use as spoken dialogue by a virtual character.”

Server outputs this prompt sentence for use in the next invocation of the generative AI model.

### Step 17:

Server constructs a prompt sentence for character-change processing when the request is identified as a change request.

Server uses user attribute information, current persona configuration, and change-request content (e.g., “younger style,” “more professional”) as input.

Server outputs a prompt sentence such as:
“Rewrite the following sales dialogue so that it is spoken by a calm professional advisor avatar.
Maintain all product facts and use polite, respectful language.
Original dialogue: [previous script text].”

### Step 18:

Server sends the newly constructed prompt sentence to the generative AI model and obtains updated response information.

Server uses the appropriate prompt sentence and model control parameters as input and issues a model-inference call.

Server receives modified dialogue text or an answer to the user's question as output and stores it temporarily for further processing.

### Step 19:

Server updates customer-service content and, if necessary, persona parameters based on the new response information.

Server uses the response information and the previous persona configuration as input and adjusts persona fields such as role description, tone, and emotional style when a character-change operation is requested.

Server outputs updated customer-service content and updated display control information, again including dialogue text, animation cues, and appearance settings.

### Step 20:

Server transmits the updated display control information to terminal and logs interaction history information.

Server uses the updated display control information and session identifier as input and sends it to terminal.

Server simultaneously records interaction history information and any associated sales result information as output, writing them to storage for later evaluation.

### Step 21:

Terminal receives the updated display control information and refreshes the presentation of the virtual interactive agent.

Terminal uses updated avatar parameters and dialogue text as input and switches the on-screen character appearance and voice settings.

Terminal outputs a modified visual representation and audio stream that reflect the requested persona change or new answer content.

### Step 22:

Server periodically evaluates interaction quality and sales performance based on accumulated logs.

Server uses interaction history information, sales result information, and user feedback information as input and computes evaluation metrics such as conversion rate, average rating, and early-termination frequency.

Server outputs evaluation results and aggregated evaluation information that summarize performance per persona, per prompt template, and per recommendation policy.

### Step 23:

Server generates optimization-oriented prompt sentences to request improvement plans from the generative AI model.

Server uses evaluation information and current prompt templates as input and constructs text such as:

“Based on the following performance summary, propose three improvements to the dialogue script and sales promotion strategy for the virtual assistant.

Performance summary: [summary text].

Task: Suggest specific changes in greeting, recommendation order, and follow-up questions.”

Server outputs these optimization prompt sentences and passes them to the generative AI model in a batch or scheduled process.

### Step 24:

Server receives improvement plans from the generative AI model and updates internal templates and policies.

Server uses the model-generated improvement content as input and parses it into concrete modifications of dialogue script templates, prompt sentence patterns, and recommendation rules.

Server writes these updated templates and policies to configuration storage as output, thereby influencing future prompt generation and generative AI model invocations.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented customer service systems that utilize rule-based recommendation engines or static message templates suffer from several technical limitations. First, such systems typically rely on pre-defined segment rules and fixed dialogue scripts, which are stored and executed in software components without dynamically adapting their internal control logic based on fine-grained, time-series user interaction data. As a result, the processing performed by the processor remains largely static, and the system is unable to exploit the full expressiveness of a generative AI model or to continuously refine prompt sentences in response to measured performance, thereby limiting the efficiency and effectiveness of the underlying computation.

Second, existing systems that incorporate generative AI models often treat the model as a black-box text generator invoked with manually designed prompts. These systems do not maintain a structured, machine-readable association between (i) user-related feature quantities derived from purchase history and behavior history, (ii) avatar configuration parameters such as appearance and voice style, (iii) concrete prompt sentences supplied to the generative AI model, and (iv) downstream service quality and sales performance indexes. In the absence of such associations, the processor cannot systematically adjust the generation rules or templates of prompt sentences. This leads to suboptimal use of computing resources, because the generative AI model repeatedly executes under non-optimized input conditions, and the system cannot algorithmically converge to better-performing configurations.

Third, many known architectures are not designed to process user interaction events as structured, time-series data streams that feed back into the generative AI prompting pipeline. Event logging, if present, is often implemented as unstructured logs that are not tightly integrated with the logic that constructs prompts. Consequently, the processor cannot effectively compute feature quantities such as category-specific purchase ratios, visit frequencies, promotion reaction metrics, and dialogue duration metrics, and cannot feed these feature quantities into a prompt-optimization loop. This results in a technical shortcoming where the data path from user actions to prompt generation remains fragmented, limiting the system's ability to achieve real-time or near real-time optimization.

Fourth, conventional systems generally separate avatar customization from dialogue generation logic. Avatar appearance and voice settings are usually handled only at the user interface layer, without being encoded into the control data that governs how the generative AI model is prompted. Thus, there is no unified data structure or control flow whereby the processor can incorporate avatar configuration into the prompt sentence and, based on measured response performance, adjust both the speaking style and content of the AI-generated messages. This separation prevents the processor from performing coordinated optimization of visual, auditory, and linguistic aspects of the interaction, and leads to inefficiencies in utilizing the capabilities of the generative AI model and the associated hardware resources in the terminal and server.

Accordingly, there is a need for an improved computer-implemented system and server-side processing architecture that (i) acquires and aggregates user-related information and event information as structured, time-series data, (ii) derives and updates user attribute and segment information as feature quantities, (iii) programmatically generates and refines prompt sentences supplied to a generative AI model, (iv) records and correlates prompt sentences, avatar settings, and performance indexes, and (v) automatically updates prompt templates and generation rules based on comparative evaluation. Such a system should improve the functioning of the computer itself by enabling the processor to more efficiently control calls to the generative AI model, optimize the content and style of responses in a data-driven manner, and thereby realize an adaptive, high-performance One-to-One customer service mechanism that is technically superior to conventional static or manually tuned systems.

The specific processing by the specific processing unit 290 of the data processing device 12 in Application Example 1 is realized by the following means.

The present invention provides a server comprising a processor and a storage unit, the processor being configured to acquire, from a terminal, user-related information including purchase history information and behavior history information of a user, aggregate the user-related information by using a data analysis program and a data analysis library to generate feature quantities, and identify attribute information and user segment information related to the user; to generate, on the basis of the attribute information, the user segment information, display style information and voice output style information related to a virtual character, and a current behavior state of the user, a prompt sentence that instructs generation of product proposal information and sales promotion information for the user, and to input the prompt sentence to a generative AI model so as to cause the generative AI model to generate a response text including the product proposal information and the sales promotion information; to transmit the response text to the terminal and cause the terminal to present the response text in a dialogue format via a display interface and a speech synthesis function of the virtual character, to acquire, from the terminal, customization information including appearance setting information and voice setting information of the virtual character, and to store the customization information in the storage unit such that the customization information is reflected in a writing style and an expression style of a subsequently generated prompt sentence and response text; and to record, in the storage unit, operation history information and purchase result information of the user acquired from the terminal after presentation of the product proposal information and the sales promotion information in association with the prompt sentence and the response text, to calculate a service quality index and a sales performance index on the basis of the recorded information, and to update generation rules and template information of the prompt sentence according to the service quality index and the sales performance index so as to sequentially optimize the prompt sentence to be input to the generative AI model and contents of the product proposal information and the sales promotion information. This enables the processor to implement a feedback-controlled prompt generation and optimization loop that tightly couples time-series user interaction data, avatar configuration parameters, and performance indexes, thereby improving the operation of the computer system by dynamically adapting the control data supplied to the generative AI model, reducing ineffective model calls, enhancing the quality and relevance of generated responses, and achieving more efficient and scalable personalized customer service.

The term “user-related information” refers to information associated with a user, including, but not limited to, purchase history information, behavior history information, and other data indicating the user's interactions with products, services, or a system over time.

The term “purchase history information” refers to information indicating past purchase activities of a user, including, but not limited to, purchased product identifiers, purchase dates and times, purchase quantities, purchase prices, and purchase channels.

The term “behavior history information” refers to information indicating actions performed by a user in relation to products or services, including, but not limited to, page views, item clicks, cart additions, search queries, dwell times, and navigation paths within an application or website.

The term “terminal” refers to an information processing device operated by a user, including, but not limited to, a mobile device, a wearable device, a tablet, a personal computer, or any network-connected client device capable of transmitting and receiving data.

The term “data analysis program” refers to a software component executed by a processor to perform operations on data, including, but not limited to, data aggregation, filtering, transformation, and computation of statistical values.

The term “data analysis library” refers to a collection of program routines or software modules that provide functions for processing data, including, but not limited to, operations for loading, aggregating, grouping, and analyzing datasets and generating feature quantities. The term “feature quantity” refers to a numerical or categorical value derived from raw data, including, but not limited to, purchase ratios, visit frequencies, reaction counts, and duration metrics, which is used by a processor to characterize user behavior or attributes.

The term “attribute information” refers to information that characterizes a user on the basis of feature quantities, including, but not limited to, preferences, interests, purchase tendencies, and sensitivity to promotions.

The term “user segment information” refers to information indicating a classification or grouping of a user into one of a plurality of user segments, each segment being defined by common behavioral patterns, attribute information, or feature quantity ranges.

The term “virtual character” refers to a computer-generated agent used for interaction with a user, including, but not limited to, a graphical avatar, an animated figure, or a character representation that can display expressions and output speech.

The term “display style information” refers to information defining how a virtual character or related content is visually presented, including, but not limited to, character appearance, color schemes, clothing styles, and animation patterns.

The term “voice output style information” refers to information defining how speech associated with a virtual character is output, including, but not limited to, voice type, pitch, speaking speed, tone, and degree of formality.

The term “current behavior state of the user” refers to information indicating one or more actions or contexts of a user at or near a present time, including, but not limited to, currently viewed items, items in a cart, or ongoing browsing or interaction sessions.

The term “prompt sentence” refers to a natural language text or structured instruction input to a generative AI model, which specifies a task to be performed by the model, including, but not limited to, generation of product proposal information and sales promotion information. The term “generative AI model” refers to a machine learning model that generates data in response to input data, including, but not limited to, a language model configured to generate text based on a prompt sentence.

The term “product proposal information” refers to information recommending one or more products to a user, including, but not limited to, product names, descriptions, usage suggestions, and comparative explanations tailored to the user's attributes or behavior.

The term “sales promotion information” refers to information intended to promote the sale of products or services, including, but not limited to, discount details, limited-time offers, campaigns, coupons, and bundled offers.

The term “response text” refers to text output from a generative AI model in response to a prompt sentence, the text including, but not limited to, product proposal information, sales promotion information, and explanatory or conversational content.

The term “display interface” refers to a user interface component on a terminal that presents visual information, including, but not limited to, a graphical user interface, a screen region showing a virtual character, and associated text or images.

The term “speech synthesis function” refers to a function or module that converts text into audio signals, including, but not limited to, a text-to-speech engine configured to output synthesized speech corresponding to a response text.

The term “customization information” refers to information that specifies user-selected settings for a virtual character, including, but not limited to, appearance setting information and voice setting information.

The term “appearance setting information” refers to information defining visual attributes of a virtual character, including, but not limited to, hairstyle, facial features, body shape, clothing, colors, and accessories.

The term “voice setting information” refers to information defining audio attributes of a virtual character's voice, including, but not limited to, voice identity, pitch, speed, timbre, language, and speech style.

The term “storage unit” refers to a hardware or software component capable of storing data, including, but not limited to, a memory device, a storage device, or a database system.

The term “operation history information” refers to information indicating user operations performed via a terminal, including, but not limited to, button presses, item selections, scroll actions, message inputs, and avatar customization operations.

The term “purchase result information” refers to information indicating outcomes of purchase-related processes, including, but not limited to, whether a purchase occurred, which product was purchased, the purchase quantity, and the purchase amount.

The term “service quality index” refers to a numerical or categorical indicator representing a quality level of service provided to a user, including, but not limited to, metrics derived from user engagement, response rates, dwell times, or explicit or implicit feedback.

The term “sales performance index” refers to a numerical or categorical indicator representing a sales outcome, including, but not limited to, conversion rates, revenue per user, revenue per session, or promotion effectiveness.

The term “generation rules of the prompt sentence” refers to rules, parameters, or algorithms used by a processor to construct a prompt sentence, including, but not limited to, selection of template structures, insertion of attribute information, and control of tone and length.

The term “template information of the prompt sentence” refers to one or more predefined text patterns or structures used as a basis for generating a prompt sentence, including, but not limited to, format strings, placeholders, and associated conditions for their use.

The term “event information” refers to information describing discrete occurrences in a system, including, but not limited to, user actions, system notifications, and interaction events, each associated with at least a type, a timestamp, and related context.

The term “time-series information” refers to information that includes temporal ordering, including, but not limited to, timestamps or sequence identifiers, enabling processing of data in a chronological or sequential manner.

The term “purchase ratio information for each product category” refers to information indicating relative or absolute proportions of purchases made by a user for different product categories within a given period.

The term “visit frequency information” refers to information indicating a frequency with which a user accesses or visits a system, an application, or specific content, including, but not limited to, counts of sessions or visits per unit time.

The term “reaction information to the sales promotion information” refers to information indicating how a user responds to sales promotion information, including, but not limited to, clicks, views, dismissals, redemptions, and related interaction metrics.

The term “dialogue duration information with the virtual character” refers to information indicating an amount of time or number of exchanges within an interaction between a user and a virtual character.

The term “prompt sentence template” refers to a predefined structure or pattern used for generating a prompt sentence, including, but not limited to, a text form with variable placeholders into which attribute information, segment information, or other data are inserted. The term “comparative evaluation” refers to a process in which two or more prompt sentence templates or related configurations are compared based on performance metrics, including, but not limited to, service quality indexes and sales performance indexes.

In one embodiment, a server, a terminal, and a user cooperate to implement the invention.

The server includes at least one processor, a memory, a storage unit, and a network interface. The server executes a server-side program implemented, for example, in a general-purpose programming language such as Python, using a web application framework such as a lightweight web framework, and a data analysis library such as a table-oriented data analysis library. The server accesses a relational data storage system such as a row-based relational database. The server also accesses a generative AI model via a network-based application programming interface. The generative AI model is implemented as a neural network language model, for example a transformer-based architecture with multi-head self-attention layers, feed-forward layers, and positional encodings, trained on large-scale text corpora. The terminal includes at least one processor, a display device, an audio output device, an input device such as a touch panel or microphone, a memory, and a network communication module. The terminal executes a client application implemented, for example, as a mobile application (for a smartphone or tablet) or as a browser-based application. The client application displays a virtual character (avatar) in 2D or 3D graphics and reproduces synthesized speech corresponding to text received from the server.

The user operates the terminal to browse products, receive recommendations from the virtual character, and customize the appearance and voice of the virtual character. The user performs operations such as tapping on product images, scrolling lists, selecting avatar attributes, and confirming purchases. The terminal converts these operations into structured event records.

The server acquires user-related information from the terminal as structured messages over a network protocol such as HTTPS. The user-related information includes purchase history information and behavior history information. The behavior history information includes, for example, item view events, item click events, add-to-cart events, and timing information such as timestamps. The terminal represents each event as a record consisting of a user identifier, an event type, an item identifier, a timestamp, and optional metadata (for example, screen type and session identifier) and transmits these records to the server.

The server stores the received event records into database tables with predefined schemas, for example tables for user events, purchase transactions, and avatar configurations. The server then uses the data analysis library to load event records for a given user into an in-memory data frame. The server performs transformation operations such as grouping by product category, counting events, computing time differences between events, and joining purchase events with viewing events. The server defines specific feature quantities, such as a purchase ratio per product category, a visit frequency per time unit, a reaction count to sales promotion information, and a dialogue duration with the virtual character. The server computes these feature quantities from raw event records using vectorized data operations.

The server derives attribute information and user segment information from the feature quantities. In one embodiment, the server uses rule-based logic, for example assigning a “sneaker-focused” attribute when a sneaker purchase ratio exceeds a threshold, or assigning a “high-frequency visitor” attribute when a visit frequency exceeds a threshold. In another embodiment, the server uses a machine learning classifier, such as a gradient boosting classifier or a neural network classifier, to map feature vectors to discrete user segments. The server stores attribute information and user segment information in a dedicated table so that subsequent processing modules can access them without recomputing base statistics.

The server manages display style information and voice output style information related to the virtual character. The terminal provides avatar customization interfaces that allow the user to select appearance attributes (for example, hairstyle type, clothing category, color scheme) and voice attributes (for example, pitch range, speaking speed, formality level). The terminal sends the selected appearance setting information and voice setting information to the server as structured records. The server stores these settings in an avatar settings table indexed by user identifier. Thus, the server maintains stable associations among user identifiers, attribute information, user segment information, and avatar configuration parameters.

The server generates a prompt sentence for a generative AI model by combining the attribute information, user segment information, avatar settings, and a current behavior state of the user. The server constructs the prompt sentence based on templates stored in a template repository. Each template contains fixed text segments and variable placeholders that are replaced with attribute values and context values at runtime. For example, the server may generate a prompt sentence such as:
“The user's past purchase history is mainly sneakers, and the user is currently browsing running shoes. Please act as a professional in-store salesperson and generate a friendly, enthusiastic sales talk that recommends two new running sneaker models, each with a brief explanation of its features. Include one sentence about a limited-time discount. The speaking style should match a casual, energetic avatar.”

In another example, the server may generate a prompt sentence such as:
“The user's past purchase history is sneakers. Please generate a courteous, concise sales talk recommending new sneakers suitable for daily use, using a calm tone appropriate for a low-pitched voice avatar.”

The server sends the prompt sentence to the generative AI model via the network interface. The generative AI model is, for example, a transformer-based language model including multiple layers of self-attention and feed-forward networks, with parameters (weights) optimized by a gradient-based learning algorithm such as Adam during pre-training. During generation, the server specifies decoding parameters such as temperature, maximum token count, and top-k or nucleus sampling thresholds, which control the diversity and length of the generated response text. The server transmits the prompt sentence and decoding parameters, receives generated tokens, and assembles them into a response text.

The server parses the response text and may optionally post-process it. For example, the server may scan the text for product descriptions and map them to known product identifiers using keyword matching or vector similarity search in an embedding index. The server then encapsulates the response text, and, when available, associated product identifiers, into a response message and transmits the message to the terminal.

The terminal receives the response text and displays it in association with the virtual character. The terminal renders the avatar on the display device and shows the response text as dialogue text, for example in a speech balloon or chat bubble. The terminal also uses a speech synthesis function, such as a text-to-speech engine executing on the terminal or on a connected service, to convert the response text into audio output. The terminal applies voice settings received from the server (for example, pitch and speed) to select appropriate synthesis parameters, and outputs the synthesized speech through the audio output device. In this way, the user experiences a synchronized visual and auditory interaction with the virtual character.

The user may then react to the response text by selecting recommended items, requesting further information, or ignoring the recommendations. The user may also adjust the avatar's appearance and voice settings through the client application. The terminal converts the user's operations into further event records, including operation history information and purchase result information, and transmits these records to the server.

The server stores these additional event records and links them to the specific prompt sentence and response text that were in effect when the user reacted. In one embodiment, the server maintains an association table that relates prompt sentence identifiers, user identifiers, avatar configuration identifiers, and resulting behavior metrics such as click-through rates and purchase conversions. The server uses this association to compute a service quality index and a sales performance index for each prompt template and for each combination of attribute information, user segment information, and avatar configuration.

The server updates generation rules and template information based on the computed indexes. For example, the server may compare the service quality index of two different prompt templates that target the same user segment. The server can select the template with a higher index and increase its usage probability. In another example, the server may observe that response texts generated with a certain explicit mention of urgency (“limited-time offer”) yield higher sales performance when the service quality index surpasses a threshold. The server can then modify other templates to incorporate similar phrasing. These updates are performed automatically by program logic that analyzes performance statistics and writes updated template records back to the storage unit.

This feedback-control loop produces a technical effect in computer operation. The server reduces ineffective calls to the generative AI model by gradually eliminating poorly performing prompt templates and by converging to prompts that produce higher engagement and conversion. The server also improves computation efficiency by leveraging structured feature quantities and precomputed attribute information to generate prompts, instead of recomputing context heuristically for each interaction. Because the server encodes avatar configuration and performance metrics into machine-readable structures and uses them to control the prompt generation logic, the system optimizes the control data supplied to the generative AI model. This structured optimization is not achievable by human operators manually editing scripts, and it alters the functioning of the computer system in a non-traditional way.

The server can employ different internal configurations for the generative AI model. In one embodiment, the server uses a remotely hosted language model, and the server itself does not perform training but performs only inference. In another embodiment, the server includes a local neural network implementation that is fine-tuned using domain-specific dialogue logs. In this case, the server uses a supervised learning method in which prompt-response pairs, along with user reaction labels (for example, success or failure), are used to minimize a loss function such as cross-entropy loss or a combined loss including a term proportional to negative sales performance. The server updates weight parameters of the neural network with stochastic gradient descent or a related algorithm. The server may also use data augmentation methods such as paraphrasing of prompt sentences or perturbation of numerical attributes to improve generalization.

The server implements an internal module structure including an event ingestion module, a feature extraction module, a user profiling module, a prompt generation module, a model interface module, an evaluation module, and a template optimization module. The modules communicate via well-defined data structures, for example dictionaries or record objects, that carry feature quantities, attribute labels, prompt identifiers, and index values. This modularization allows the server to execute optimizations independently in each stage, such as caching feature vectors for frequently active users or batch-processing event logs to reduce database load. Such architectural details contribute to improved processing speed and lower communication load between the server and the generative AI model backend.

The terminal, in some embodiments, performs local pre-processing to reduce communication overhead and ensure privacy. For example, the terminal may aggregate low-level click events into higher-level summary events before transmission. The terminal may also cache the most recent avatar settings and a subset of response texts so that repeated requests are handled locally without contacting the server, thereby reducing network latency and the number of server round trips. These techniques further improve the efficiency and performance of the overall system.

Alternative embodiments are possible. In one variant, the server executes the data analysis program in a distributed processing environment to handle large volumes of user-related information. In another variant, the server uses a different type of generative AI model, such as a sequence-to-sequence model with encoder-decoder architecture, instead of a single large transformer. In yet another variant, the server uses reinforcement learning from user feedback to adjust the prompt generation rules, defining a reward function based on the service quality index and sales performance index and updating a policy over prompt templates. In each case, the server maintains the key structural features: structured event acquisition, feature-based user profiling, explicit prompt sentence construction, generative AI inference, and data-driven template optimization with feedback.

By implementing the invention in this way, the server, the terminal, and the user cooperate in an integrated feedback system in which generative AI model outputs are not merely arbitrary texts for business communication but are controlled, evaluated, and refined through technical mechanisms. The server changes its internal control flow and data structures based on measured outcomes, improving the precision of recommendations, increasing processing throughput, and reducing redundant computation. As a result, the system improves computer technology itself rather than merely automating existing human business processes.

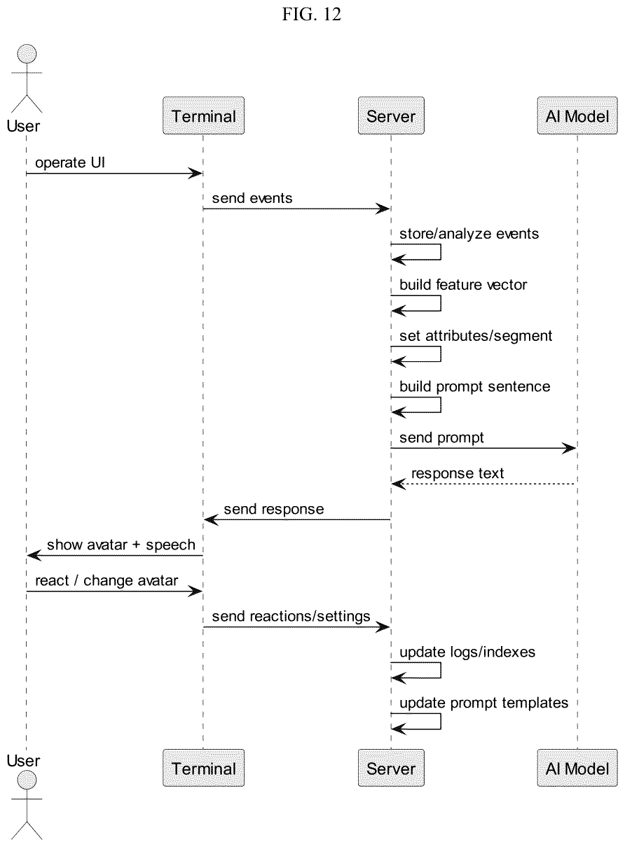

The following describes the processing flow using FIG. 12.

### Step 1:

The terminal records user actions and generates event data.

The terminal receives input from the user, such as taps on product images, scroll operations in a product list, additions of items to a shopping cart, avatar customization selections, and purchase confirmations. Based on these inputs, the terminal generates structured event records, each including at least a user identifier, an event type (for example, “view_item,” “add_to_cart,” “avatar_update,” “purchase_complete”), a content identifier (for example, product identifier or screen identifier), and a timestamp. The terminal stores these event records in a local buffer and serializes them into a data structure such as a JSON array. The output of this step is a batch of serialized event data prepared for transmission to the server.

### Step 2:

The terminal transmits event data and user-related information to the server.

The terminal takes the serialized batch of event records as input and opens a secure network connection to the server using a protocol such as HTTPS. The terminal embeds the event data in the body of an HTTP request, along with metadata such as a session identifier and a device identifier. The terminal sends the request to a designated server endpoint. The output of this step is a network message containing user-related information, including purchase history information and behavior history information, delivered to the server for processing.

### Step 3:

The server receives and stores raw event data.

The server receives the network message from the terminal as input through its network interface and parsing logic in a web framework. The server validates the format of the event records, checks for required fields, and converts timestamps into a unified time zone. The server then maps each event record to a predefined database schema and inserts the event records into corresponding tables such as a user event table, a transaction table, and an avatar configuration log table. The server may also generate unique identifiers for each event. The output of this step is a set of normalized event records stored in a relational data storage system, ready for analysis.

### Step 4:

The server aggregates event records and computes feature quantities.

The server reads the stored event records for a particular user or user group as input, using queries to the relational database. The server loads these records into an in-memory data structure such as a data frame via a data analysis library. The server then performs data processing operations, including grouping events by product category, counting the number of purchases per category, computing the total number of visits per time interval, measuring reaction counts to sales promotion messages, and calculating dialogue duration with the virtual character based on message timestamps. The server uses these operations to derive feature quantities such as “purchase ratio for each product category,” “visit frequency,” “promotion reaction rate,” and “dialogue time.” The output of this step is a feature vector or a set of feature quantities representing the user's behavior in numerical and categorical form.

### Step 5:

The server identifies attribute information and user segment information.

The server takes the computed feature quantities as input and applies classification logic. In one implementation, the server uses threshold-based rules (for example, classifying a user as “sneaker-focused” when the sneaker purchase ratio exceeds a specified value). In another implementation, the server inputs the feature vector into a trained classification model, such as a machine learning model, to map the features to a discrete user segment label. The server may also assign multiple attribute tags based on different dimensions (for example, product preference, visit frequency, sensitivity to promotions). The server writes the resulting attribute information and user segment information back into dedicated profile tables in the database. The output of this step is updated user profile data consisting of attribute labels and segment identifiers.

### Step 6:

The server acquires avatar customization settings from stored data.

The server uses the user identifier as input to query avatar configuration tables. The server retrieves the latest appearance setting information (for example, selected hairstyle type, clothing category, color scheme) and voice setting information (for example, pitch level, speaking speed, tone) that were previously transmitted from the terminal. The server combines these settings into a unified avatar configuration structure. The output of this step is a data object that describes the display style information and voice output style information associated with the virtual character for the current user.

### Step 7:

The server determines the current behavior state of the user.

The server takes the most recent event records, particularly those with the latest timestamps, as input. The server analyzes these records to detect the current context, such as which product page is currently open, whether the user is in a checkout process, or whether the user is viewing a specific category like running shoes. The server uses this information to set a current behavior state flag or context descriptor (for example, “browsing_running_shoes” or “reviewing_cart”). The output of this step is a context descriptor representing the user's current behavior state.

### Step 8:

The server generates a prompt sentence for the generative AI model.

The server uses, as input, the attribute information, user segment information, avatar configuration data, and current behavior state descriptor, together with prompt sentence templates stored in a template repository. The server selects an appropriate prompt template for the user segment, then fills template placeholders with concrete values derived from the input data. For example, the server may construct a prompt sentence such as:
“The user's past purchase history is mainly sneakers, and the user is currently browsing running shoes. Please act as a professional in-store salesperson and generate a friendly, enthusiastic sales talk that recommends two new running sneaker models, each with a brief explanation of its features. Include one sentence about a limited-time discount. The speaking style should match a casual, energetic avatar.”

The server assembles the complete prompt sentence as a string. The output of this step is a fully constructed prompt sentence ready to be input to the generative AI model.

### Step 9:

The server submits the prompt sentence to the generative AI model and receives a response text.

The server takes the prompt sentence as input and constructs a model request, specifying parameters such as a model identifier, temperature, and maximum output length. The server sends this request to the generative AI model via an API call over the network. The generative AI model executes a sequence of computations (for example, multi-head attention, feed-forward transformations, and token probability estimation) to predict a sequence of output tokens conditioned on the prompt sentence. The server receives the sequence of tokens, reconstructs them into a coherent natural language response text, and parses this text if necessary. The output of this step is a response text that includes product proposal information, sales promotion information, and dialogue expressions suited to the avatar style and user attributes.

### Step 10:

The server post-processes the response text and prepares a response message.

The server uses the raw response text as input and performs optional post-processing. The server may scan the text for product names or categories, perform lookups in a product catalog table, and associate each mentioned item with a concrete product identifier, image reference, and price. The server can also check for prohibited terms or format inconsistencies and correct them. The server then composes a structured response message that includes the response text, optional structured product recommendation data, and metadata indicating display options for the terminal. The output of this step is a structured response message generated from the model output and ready for transmission to the terminal.

### Step 11:

The server transmits the response message to the terminal.

The server takes the structured response message as input and sends it through a network interface to the terminal using a protocol such as HTTPS or a push notification service. The server may assign a unique identifier to this response message and log the association between this identifier and the prompt sentence used to generate it. The output of this step is a network response that delivers the response text and related data to the terminal.

### Step 12:

The terminal renders the virtual character and presents the response text.

The terminal receives the structured response message as input. The terminal parses the response text and product recommendation data, updates a user interface layout, and displays the virtual character on the display device, for example overlaying a speech balloon containing the response text. The terminal concurrently sends the response text to a speech synthesis function, applies voice settings (pitch, speed, tone) obtained from the server or stored locally, and generates an audio stream. The terminal outputs the audio through speakers and synchronizes avatar mouth movement and facial expressions with the playback. The output of this step is a combined visual and audio presentation of the AI-generated message to the user.

### Step 13:

The user interacts with the recommendations and adjusts avatar settings.

The user observes the avatar's dialogue and the displayed recommended items as input. The user may tap a recommended product, request more details via a button or text input, ignore the suggestion, or navigate away. The user may also open an avatar configuration screen and change appearance or voice options. These user operations become new inputs to the terminal, which converts them into updated event records such as “recommendation_clicked,” “product_purchased,” or “avatar_settings_changed.” The output of this step is a new set of user interaction events and updated avatar configuration selections.

### Step 14:

The terminal sends operation history information and avatar customization information to the server.

The terminal takes the new event records and avatar settings as input, packages them into one or more messages, and transmits them to the server using HTTP requests or a similar protocol. Each message includes identifiers that link the events to the previously received response message and prompt sentence. The output of this step is a set of operation history information and customization information delivered to the server for logging and analysis.

### Step 15:

The server logs user reactions and correlates them with prompt sentences and response texts. The server receives operation history information and avatar customization information as input. The server updates internal tables to record, for each prompt sentence identifier and response message identifier, the corresponding user reactions such as clicks, purchases, or dismissals. The server links these reactions to specific attribute information, user segment information, and avatar settings stored in the profile tables. The output of this step is a comprehensive interaction log that associates prompt sentences and response texts with concrete user outcomes.

### Step 16:

The server calculates service quality indexes and sales performance indexes.

The server uses the correlated interaction log as input and executes statistical computations. The server groups logs by prompt template, user segment, and avatar configuration, and then computes metrics such as click-through rate, conversion rate, average revenue per response, and average dialogue duration. The server normalizes these metrics to generate service quality indexes (for example, engagement scores) and sales performance indexes (for example, conversion-based scores) for each combination. The output of this step is a set of indexes representing the effectiveness of different prompt templates and configurations.

### Step 17:

The server updates generation rules and prompt sentence templates based on performance indexes.

The server takes the service quality indexes and sales performance indexes as input and applies optimization logic. The server compares indexes for multiple prompt templates targeting the same user segment and determines which templates perform best. The server updates generation rules by, for example, increasing the selection probability of high-performing templates, disabling low-performing templates, or adjusting text phrases within templates. In some configurations, the server may apply a learning algorithm to update template parameters (for example, weights indicating the likelihood of including urgency phrases or discount mentions) according to observed performance. The output of this step is an updated set of prompt generation rules and templates that will be used in future prompt sentence construction.

### Step 18:

The server stores updated templates and rules for subsequent interactions.

The server uses the modified prompt templates and generation rules as input and writes them into a template repository in the storage subsystem. The server ensures that these updated templates are indexed by user segment, attribute combinations, and avatar styles, so that they can be efficiently retrieved during future interactions. The output of this step is a persistent configuration state in which the server's behavior for generating prompt sentences is altered and improved for subsequent executions.

### Step 19:

The server, terminal, and user iteratively repeat the interaction cycle with improved behavior. The server uses the updated templates during future prompt creation; the terminal continues to send new event data; and the user continues to interact with the virtual character. At each cycle, the inputs consist of new user-related information, updated feature quantities, and refined templates, and the outputs consist of more tailored prompt sentences, more contextually appropriate response texts, and updated performance indexes. Over time, this iterative process causes the system to converge toward better-performing prompts and interactions, enhancing both computational efficiency and the technical quality of responses generated by the generative AI model.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialog systems and sales support systems using machine learning or rule-based engines generally treat generative models as static components that return responses to user inputs without deeply integrating runtime dialog logs, user operation histories, and transaction results into a closed feedback loop. As a result, such systems suffer from several technical problems in the field of computer technology.

First, existing systems often construct input data for a generative AI model in an ad hoc manner, for example by simply concatenating recent dialog turns and a generic instruction. These systems do not systematically structure prompt sentences into layers such as system-level prompt sentences and task-level prompt sentences, nor do they automatically adapt these layers per user segment on the basis of quantified response quality indicators. This leads to inefficient use of model context windows, increased token overhead, and unstable response behavior, thereby degrading the overall computational efficiency and predictability of the dialog engine.

Second, conventional architectures frequently log dialog content and sales results only for offline reporting, without machine-level linkage between specific prompt configurations and subsequent user behaviors. Because user operation history information and transaction result information are not stored in a form directly associated with corresponding prompt sentences and dialog turns, the system cannot compute robust evaluation indicators per prompt pattern. Consequently, the system cannot automatically refine or select prompt sentences that improve conversion while also stabilizing the generative model's behavior, which results in suboptimal use of computing resources and prolonged trial-and-error cycles at the application level.

Third, many systems rely on manual tuning by human operators to adjust prompts and dialog flows. This manual process is not integrated with machine-level statistical analysis or machine learning that runs directly on the dialog logs and transaction logs. The need for human interpretation of raw logs to update prompts increases latency in deploying improvements and makes it difficult to perform fine-grained, segment-specific optimization. From the perspective of computer technology, this represents an inefficient architecture in which the processor and storage apparatus are not orchestrated to automatically evolve the configuration of the generative AI model based on systematically computed indicators.

Fourth, existing virtual character interfaces often perform only simple formatting of model outputs, without programmatically inserting structured product attribute information and without generating alternative display formats such as shortened explanation sentences. This limits the system's ability to adapt responses to diverse terminal devices and bandwidth conditions, and may cause unnecessary token generation by the model for information that could be retrieved more efficiently from structured storage. As a result, response latency, resource utilization, and the consistency of displayed information across devices remain suboptimal.

Accordingly, there is a need for an improved computer-implemented system that: (i) structures dialog information, user operation history information, and transaction result information in a way that allows a processor to compute user characteristics and response quality indicators; (ii) uses those computed indicators to automatically update or select layered prompt sentences for a generative AI model on a per-segment basis; and (iii) integrates structured product information with generated responses in a programmatic manner. Such a system should form a closed optimization loop at the processor and storage level, thereby improving the efficiency, stability, and adaptability of generative AI-based dialog processing in sales and service environments.

The specific processing by the specific processing unit 290 of the data processing device 12 in Example 2 is realized by the following means.

The present invention provides a server comprising a processor, a storage apparatus, and a communication interface, the processor being configured to acquire, from a terminal device via the communication interface, dialog information including user attribute information and user behavior information, to store the dialog information in the storage apparatus in a structured format together with user operation history information and transaction result information, to generate input data including a system-level prompt sentence, a task-level prompt sentence, and past dialog history on the basis of the stored dialog information and product information, to input the input data to a generative AI model to cause the generative AI model to generate a response sentence, to perform format conversion processing on the generated response sentence including insertion of product attribute information and generation of a shortened explanation sentence for display, to calculate user characteristics and response quality indicators by applying statistical analysis processing or machine learning processing to the stored dialog information, user operation history information, and transaction result information, and to update or select, for each user segment defined by the user characteristics, the system-level prompt sentence and the task-level prompt sentence on the basis of the response quality indicators so that the updated or selected prompt sentences are reflected in subsequent input data for the generative AI model. This enables the server to form a closed optimization loop in which the configuration of layered prompt sentences for the generative AI model is automatically adapted per user segment based on quantified response quality indicators, thereby improving computational efficiency, response stability, and personalization accuracy in the computer-implemented dialog processing.

The term “processor” refers to a hardware circuit or a combination of hardware circuits and executable software instructions that performs arithmetic operations, logical operations, control operations, and data processing operations to implement functions of the system.

The term “storage apparatus” refers to a hardware component or a combination of hardware components that stores data and programs, including non-transitory storage such as semiconductor memory, magnetic storage, or optical storage.

The term “communication interface” refers to a hardware component and associated control logic that enables the system to send data to and receive data from external devices over a wired or wireless communication network.

The term “terminal device” refers to an information processing device operated by a user, such as a portable communication device, a computing device, or a display device, that exchanges data with the server and presents dialog content to the user.

The term “dialog information” refers to data representing exchanges between a user and a virtual dialog entity, including user messages, system responses, timestamps, user attribute information, and user behavior information.

The term “user attribute information” refers to information describing characteristics of a user, such as preferences, demographic attributes, purchase tendencies, and virtual character settings, that can be used to personalize dialog processing.

The term “user behavior information” refers to information representing actions taken by a user during interaction with the system, including input content, navigation operations, selection operations, and timing of such actions.

The term “user operation history information” refers to a record of user behavior information accumulated over time, including past clicks, selections, page transitions, and other interaction events related to dialog content.

The term “transaction result information” refers to data indicating outcomes of commercial or service-related transactions associated with dialog interactions, including purchase occurrence, purchase amount, selected items, and payment completion status.

The term “structured format” refers to a data representation in which data elements are organized according to a predefined schema, such as tables, records, or fields, enabling systematic storage, retrieval, and analysis.

The term “virtual dialog entity” refers to a software-controlled interaction agent, including a virtual character or avatar, that presents responses to a user in natural language and appears to conduct a dialog.

The term “product information” refers to structured data describing goods or services, including identifiers, names, specifications, features, pricing, and availability, stored in a product information storage apparatus.

The term “product information storage apparatus” refers to a storage apparatus or a logical storage resource that holds product information in a retrievable and updatable form.

The term “product attribute information” refers to specific elements of product information, such as feature descriptions, technical specifications, prices, and option variations, that can be inserted into generated text.

The term “system-level prompt sentence” refers to a part of input data for a generative AI model that defines global behavior of the model, including role, tone, explanation policy, and safety constraints for the virtual dialog entity.

The term “task-level prompt sentence” refers to a part of input data for a generative AI model that specifies a particular task, response objective, or sales promotion policy for a given dialog turn or sequence.

The term “prompt sentence” refers to text or structured instructions provided as input to a generative AI model to control or influence the content, style, or structure of the model's output.

The term “generative AI model” refers to a trained computational model that receives input data including prompt sentences and generates output data such as natural language text by using statistical or neural network-based generation techniques.

The term “input data” refers to a data structure supplied to a generative AI model, including one or more prompt sentences, dialog history, and optional contextual information such as product information and user characteristics.

The term “response sentence” refers to natural language text output generated by a generative AI model in response to input data that includes at least one prompt sentence and dialog context.

The term “format conversion processing” refers to processing that transforms a response sentence into a form suitable for presentation or further use, including insertion of additional information, adjustment of text structure, and adaptation to display constraints.

The term “shortened explanation sentence” refers to a concise textual representation derived from a longer response sentence, intended to summarize key information for compact display or quick user comprehension.

The term “user characteristics” refers to attributes of a user inferred or derived from dialog information, user operation history information, and transaction result information, including preferences, interests, and behavioral patterns.

The term “response quality indicators” refers to quantitative metrics that evaluate performance of dialog responses, including measures related to user engagement, follow-up actions, transaction outcomes, and user satisfaction.

The term “statistical analysis processing” refers to processing that applies mathematical or statistical methods to data, such as aggregation, distribution estimation, correlation analysis, and hypothesis testing, to derive indicators or patterns.

The term “machine learning processing” refers to processing that uses algorithms capable of learning patterns from data, such as classification, clustering, or regression algorithms, to infer user characteristics or predict response quality.

The term “user segment” refers to a group of users classified by the system based on user characteristics, such that users in the same group share similar attributes or behaviors relevant to dialog processing.

The term “sales promotion strategy” refers to a set of rules, configurations, and optimization policies used by the system to present information and recommendations in a manner that encourages transactions or other target actions.

The term “candidates of the prompt sentences” refers to multiple alternative prompt sentences, each having associated configuration information, that are available for selection or evaluation in the system.

The term “evaluation indicators” refers to numerical or categorical values computed to assess performance of prompt sentences or dialog strategies, including conversion rates, click-through rates, and response quality indicators.

The term “management display device” refers to a device used by a human manager or operator that presents system-generated information such as prompt sentence candidates and evaluation indicators, and accepts selection or configuration input.

The term “selection result by a manager” refers to information indicating choices or approvals made by a human manager through the management display device regarding the use, activation, or modification of prompt sentences.

The term “closed optimization loop” refers to a feedback structure in which the system continuously collects data on dialog interactions and outcomes, computes indicators, and automatically updates or selects prompt sentences for future interactions based on those indicators.

In one embodiment, a server cooperates with one or more terminals used by users to provide an adaptive dialog system that optimizes prompt sentences for a generative AI model based on structured logs of dialog information, user operation history information, and transaction result information. The server includes at least one processor, a storage apparatus, and a communication interface implemented on a computing platform such as a cloud-computing environment. The terminal includes at least one processor, a memory, a display, an audio interface, and a communication module, and can be realized by a smartphone, a tablet computer, a personal computer, or a dedicated kiosk device.

The server executes software components implemented, for example, using an operating system, a web server, and an application framework. The server runs a web application framework such as a generic HTTP framework, and a backend application written in a general-purpose programming language such as a scripting language. The server accesses a data management system such as a relational database management system and a key-value store. The server optionally interacts with a generative AI platform that provides a generative AI model, such as a large language model implemented with a Transformer architecture using a neural network framework.

The terminal executes a client application, for example a native mobile application or a web browser application, that provides a virtual character interface. The terminal displays text messages, character animations, and product information to the user, and accepts user inputs as text via a keyboard or as voice via a microphone. The terminal optionally uses a speech-to-text service and a text-to-speech engine to convert between speech and text.

The server stores dialog information in the storage apparatus in a structured format. The server uses a data schema including a dialog_log table, a user_profile table, an interaction_log table, a sales_log table, and a prompt_template table. The dialog_log table includes fields for conversation identifier, turn index, timestamp, user message text, system response text, prompt template identifier, and character identifier. The user_profile table includes fields for user identifier, inferred attributes, preferred character style, preferred product categories, and assigned user segment. The interaction_log table includes fields for event identifier, conversation identifier, turn index, event type, and event parameters such as clicked product or opened page. The sales_log table includes fields for transaction identifier, user identifier, product identifier, amount, and related conversation identifier. The prompt_template table includes fields for template identifier, template type, system-level prompt sentence content, task-level prompt sentence content, target user segment, and status.

The server acquires dialog information, user operation history information, and transaction result information from the terminals via the communication interface. The server parses incoming messages formatted in a structured request format, validates the data, and writes the data into the corresponding tables in the storage apparatus. The server maintains referential consistency between the tables, for example by using conversation identifiers and turn indices as foreign keys. The server also stores product information in a separate product information storage apparatus, using a schema including product identifiers, product names, product categories, specification fields, price fields, and availability fields.

The server configures and uses a generative AI model that is implemented as a neural network with a multi-layer Transformer architecture. The generative AI model includes an input embedding layer, multiple self-attention layers with multi-head attention, feed-forward layers, layer-normalization components, and an output projection layer. The generative AI model receives tokenized input sequences representing prompt sentences and dialog histories, and outputs probability distributions over tokens at each position. The server uses a decoding algorithm such as greedy decoding or sampling with a temperature parameter to generate the response sentence from the probability distributions.

The server trains or fine-tunes the generative AI model using training data that includes historical dialog pairs and product descriptions. The server encodes text into token sequences using a subword tokenizer, calculates a loss function such as cross-entropy between predicted tokens and ground truth tokens, and updates the model weights using an optimization algorithm such as stochastic gradient descent or an adaptive variant. The server optionally performs data augmentation by paraphrasing prompts, shuffling non-critical segments, or injecting noise into training inputs. The server can also use reinforcement learning from human feedback by assigning reward scores to responses and adjusting the policy of the generative AI model using policy-gradient methods.

The server generates input data for the generative AI model in a structured manner. The server retrieves, from the prompt_template table, a system-level prompt sentence and a task-level prompt sentence appropriate for the current user segment and scenario. The server constructs a token sequence that includes: a segment representing the system-level prompt sentence, a segment representing prior dialog history, a segment representing the task-level prompt sentence, and a segment representing the current user message. The server separates segments using special delimiter tokens recognized by the model. The server uses explicit tokens to encode meta-information such as user segment labels, product category tags, and tone identifiers. By encoding such meta-information as tokens rather than as external configuration, the server allows the generative AI model to condition its generation on structured contextual cues.

The server constructs the system-level prompt sentence to define a role, tone, and explanation policy of the virtual dialog entity. For example, the server can use the following system-level prompt sentence:
“Act as a knowledgeable but friendly virtual sales assistant in a smartphone shop. Always adapt your explanation to a general customer with limited technical background. Focus on benefits, not raw specifications.”

The server constructs the task-level prompt sentence to define a specific response objective and sales promotion policy for a particular turn. For example, the server can use the following task-level prompt sentence:
“For a user who cares primarily about camera quality and battery life, explain the recommended smartphone in 3-4 sentences. Emphasize camera features and battery duration, and mention price only briefly at the end.”

The server can also use a more concrete prompt sentence that includes the user's question and product information:
“Act as a friendly virtual sales assistant for a mobile phone shop. The user profile is: prefers high-quality camera, medium price range, interested in battery life. Based on the following product data and the user's question, explain the main features of the recommended smartphone in 3-4 concise sentences, focusing on camera and battery benefits. Avoid technical jargon and keep the tone polite and helpful. User question: ‘What are the main features of this new smartphone?’ Product data: [product specifications expressed in natural language].”

The server incorporates the above prompt sentences into the input data for the generative AI model, thereby controlling the behavior of the model in a structured and repeatable manner.

The server adjusts model parameters such as maximum token length, temperature, and top-k or top-p sampling settings in association with each prompt template, and stores these settings in the prompt_template table, so that the same configuration can be consistently re-used and evaluated across multiple sessions.

The server performs format conversion processing on the response sentence generated by the generative AI model. The server parses the generated text and detects designated placeholders or patterns such as “{product_name}”, “{price}”, or “{battery_capacity}”. The server retrieves corresponding product attribute information from the product information storage apparatus by issuing structured queries based on product identifiers or keywords. The server replaces the placeholders in the response sentence with the retrieved product attribute information, and, if necessary, normalizes numerical values and units to a standardized format. The server then generates one or more shortened explanation sentences. The server can apply a rule-based algorithm that selects the first few sentences and truncates them to a predetermined length, or can call the generative AI model with another prompt sentence such as:
“Summarize the following answer in two short bullet points suitable for display next to a ‘Buy’ button. Focus on the most important benefits for a general customer.”

The server stores both the original response sentence and the shortened explanation sentence in the dialog_log table, so that the system can later analyze which format is more effective. The terminal receives the response sentence and the shortened explanation sentence from the server and displays them to the user. The terminal presents the text in a chat-style interface with a virtual character avatar. The terminal may convert the response sentence into speech using a text-to-speech engine and synchronize character animations with the speech. The terminal additionally displays product images and a “Buy” button or “Details” button, using product identifiers contained in the server's response payload. The user can tap the “Buy” button or “Details” button, scroll through product details, or input further questions.

The server collects user operation history information from the terminals. The terminal transmits events such as “button_click”, “detail_view”, “add_to_cart”, and “purchase_complete” with parameters including product identifiers and timestamps. The server writes these events into the interaction_log and sales_log tables. The server associates each event with a particular dialog turn by referencing the conversation identifier and turn index included in the event. Because the server stores this association in a structured format, the server can later calculate response quality indicators that connect a specific prompt template to specific user behaviors and transaction outcomes.

The server calculates user characteristics and response quality indicators using statistical analysis processing and machine learning processing. The server uses data processing libraries executed on the processor to load dialog logs and transaction logs into in-memory data structures. The server performs grouping operations by user identifier and by prompt template identifier. The server calculates measures such as the average number of turns per session, the probability that a user viewing a product explanation will click a product link, and the probability that a user clicking a product link will complete a purchase. The server calculates confidence intervals and statistical significance for differences between groups using tests such as chi-square tests or t-tests. The server computes user characteristics such as “camera-focused user” or “budget-conscious user” based on aggregated frequencies of questions and purchases across product categories.

The server applies machine learning algorithms such as clustering and classification to the aggregated data. The server constructs feature vectors for each user, including features such as the proportion of questions about a particular category, the distribution of session durations, the frequency of purchases, and the types of prompt templates that have historically produced successful outcomes. The server applies clustering algorithms to partition users into user segments. The server writes segment labels into the user_profile table. The server also trains classification models to predict which prompt templates are likely to yield higher response quality indicators for given user characteristics. The server uses these models to automatically select or recommend prompt templates for future sessions.

The server updates system-level prompt sentences and task-level prompt sentences per user segment. The server reads statistics from the prompt_template table and the sales_log table and calculates a composite score for each prompt template, such as a weighted combination of conversion rate, click-through rate, and average revenue. The server compares these scores across templates within the same target segment. The server deactivates templates with low scores and activates or prioritizes templates with high scores. The server updates the prompt_template table accordingly. The server then uses the updated table when constructing input data for the generative AI model. As a result, the server automatically steers the generative AI model to use more effective prompt sentences for each user segment.

The server provides a management display device with a graphical interface for administrators. The server presents candidates of prompt sentences, along with evaluation indicators such as conversion rate and click-through rate, in tabular or graphical form. The server allows the administrator to filter templates by segment, sort templates by performance, and manually approve or reject templates. The server receives the selection result from the administrator and writes the result into the prompt_template table, marking templates as active, experimental, or deprecated. The server thus allows human oversight while still enabling automatic prompt optimization.

The described configuration improves computer technology in several ways. The server structures dialog information, user operation history information, and transaction result information into relational schemas and feature vectors that are directly consumable by statistical and machine learning algorithms. This structured integration allows the server to compute response quality indicators in a machine-usable manner and to automatically reconfigure prompt sentences without human decoding of raw logs. This reduces the number of manual iterations required for tuning and shortens the feedback loop between user behavior and system configuration.

The server also improves computational efficiency and resource utilization of the generative AI model. By separating system-level prompt sentences and task-level prompt sentences and encoding user segment labels and product categories as compact tokens, the server reduces redundant text in the input data, thereby shortening the token sequences processed by the generative AI model. This reduces the number of neural network operations per request, decreases response latency, and lowers computational cost. The server further reduces token generation by retrieving structured product attribute information from the product information storage apparatus and inserting it into response sentences after generation, rather than requiring the generative AI model to generate detailed specifications from memory.

The server improves response stability and prediction accuracy by associating prompt templates with measured response quality indicators. Because the server records prompt template identifiers for each dialog turn and links them to subsequent events and transactions, the server can reliably estimate which templates perform better and adjust its configuration accordingly. This systematic linkage permits a closed optimization loop that goes beyond simple logging and reporting. The server maintains internal data structures and algorithms that are not equivalent to a human reading and adjusting prompts; instead, the server uses numerical metrics and machine learning methods to perform fine-grained and continuous adaptation that would not be feasible manually at the same scale and speed.

In addition, the generative AI model in the present invention operates under explicit control of structured prompt sentences and meta-tokens that encode user segments and policies. This control scheme is different from conventional static prompts and simple concatenation of history, because the system imposes non-conventional constraints and patterns at the token level. By designing prompt templates and meta-tokens to align with the architecture of the Transformer model, the server can guide the attention mechanisms within the model to relevant parts of the input, improving response relevance and consistency. This alignment between data structures and neural network behavior constitutes an improvement to the technical operation of the computing system itself.

Alternative embodiments can vary individual components while maintaining the overall structure. The server can use different database technologies, such as document databases instead of relational databases, as long as the dialog information, user operation history information, transaction result information, and prompt templates are stored in a structured and linkable form. The generative AI model can be an encoder-decoder model or a decoder-only model, and can run on dedicated hardware, on-premise servers, or external AI services. The machine learning algorithms used for segmentation and evaluation can be replaced by other algorithms such as gradient-boosted trees or neural network classifiers. The format conversion processing can include additional operations such as translation or rewriting for accessibility. The terminal can be a head-mounted display, a voice-only device, or a large-screen kiosk.

Through the above configurations, the server, the terminal, and the user cooperate to realize a computer-implemented dialog system in which generative AI model behavior is dynamically optimized by structured, machine-level feedback from real interactions. The server transforms raw dialog data and transaction data into structured signals that reconfigure prompt sentences and model inputs, thereby improving processing speed, prediction accuracy, and resource utilization in a manner that is specific to the architecture and operation of the computing system, and not merely an automation of human decision making.

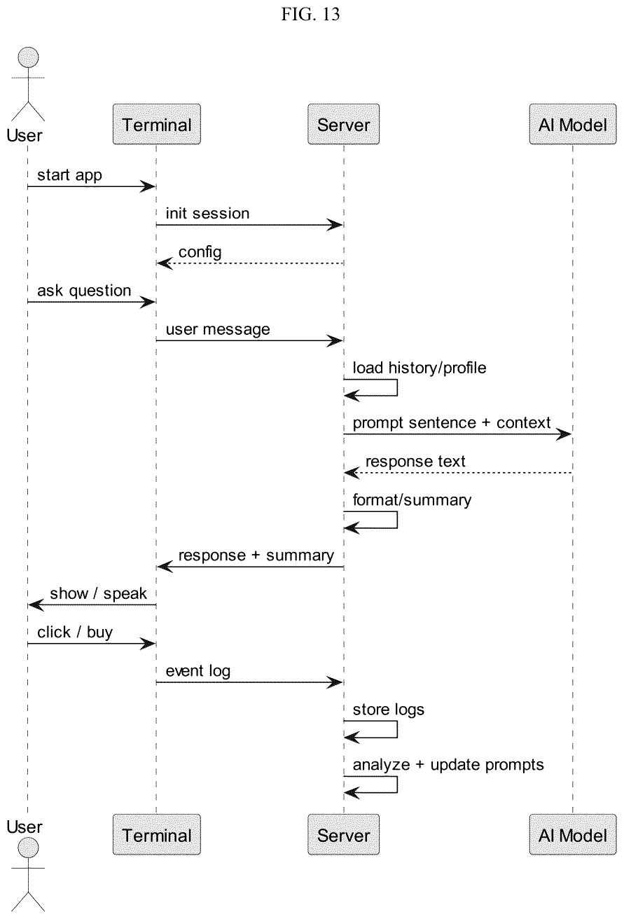

The following describes the processing flow using FIG. 13.

### Step 1:

The user activates the virtual character application on the terminal.

The terminal initializes a session by generating a conversation identifier as input and creating an in-memory context object as output. The terminal associates the conversation identifier with device information, language settings, and, if available, a user identifier. The terminal transmits a session initialization message including the conversation identifier and user identifier to the server.

### Step 2:

The server receives the session initialization message from the terminal as input. The server parses the message, validates the user identifier, and queries a storage apparatus to obtain a user profile as output. The server loads user attribute information, past interaction summaries, and preferred virtual character settings into a memory cache keyed by the conversation identifier. The server transmits initial configuration data, including available character options and language settings, to the terminal.

### Step 3:

The user selects a virtual character and optionally adjusts tone or style preferences on the terminal.

The terminal uses the selection input to update its local context, and constructs a character configuration message as output. The terminal transmits the character configuration message, including a character identifier and style parameters, to the server.

### Step 4:

The server receives the character configuration message as input. The server updates the corresponding user profile record and conversation context record in the storage apparatus, storing the character identifier and style parameters as output. The server generates a short confirmation message indicating that the character configuration has been set, and sends the confirmation to the terminal.

### Step 5:

The user inputs a question or request using the terminal, either by typing text or speaking into a microphone.

The terminal receives raw user input as input data. When the user speaks, the terminal invokes a speech-to-text component, which converts audio samples into text tokens and then into a user message string as output. The terminal packages the user message string, conversation identifier, user identifier, and timestamp into a structured request object and transmits it to the server.

### Step 6:

The server receives the structured request object from the terminal as input. The server validates the structure, normalizes character encoding, and removes extraneous whitespace and unsupported control characters. The server logs the raw input into a raw_request_log table as an output record. The server then extracts the user message string, conversation identifier, and user identifier as normalized dialog input for further processing.

### Step 7:

The server retrieves dialog history for the conversation identifier as input by querying a dialog_log table or an in-memory cache. The server selects a subset of past dialog turns based on recency and length constraints, and generates a dialog history segment as output. The server also retrieves user profile data, including user attributes, user segment label, and character preferences, from a user profile table.

### Step 8:

The server constructs a system-level prompt sentence using the user segment label and character preferences as input. The server generates a text string that defines the role, tone, and general behavior of the virtual dialog entity as output. For example, the server generates: “Act as a knowledgeable but friendly virtual sales assistant in a smartphone shop. Always adapt your explanation to a general customer with limited technical background. Focus on benefits, not raw specifications.”

### Step 9:

The server constructs a task-level prompt sentence using the current user message string and user attributes as input. The server determines which product category and which benefits are likely to be relevant, and generates a text string that defines the specific response goal and emphasis as output. For example, the server generates:
“For a user who cares primarily about camera quality and battery life, explain the recommended smartphone in 3-4 sentences. Emphasize camera features and battery duration, and mention price only briefly at the end.”

### Step 10:

The server queries a product information storage apparatus using product identifiers or category tags derived from the user message and user profile as input. The server obtains structured product information records, including specification fields and price fields, as output. The server converts key product attributes into human-readable description snippets and short labels, and stores them as product description text segments.

### Step 11:

The server assembles input data for the generative AI model using the system-level prompt sentence, the dialog history segment, the task-level prompt sentence, the product description text segments, and the current user message as input. The server concatenates these components into a single token sequence, separated by special delimiter tokens, and encodes meta-information as special tokens for user segment and product category. The server outputs a fully constructed model input object containing tokenized text, model parameters (maximum token length, temperature, sampling options), and a model identifier.

### Step 12:

The server transmits the model input object to the generative AI model as input via an inference API. The generative AI model, implemented as a multi-layer Transformer network, performs token embedding, multi-head attention, and feed-forward computation to obtain token probability distributions. The server receives, as output, a generated token sequence representing a response sentence, along with metadata including token counts and inference latency.

### Step 13:

The server decodes the generated token sequence into a response sentence string as input for post-processing. The server checks the content for prohibited patterns and applies filtering rules, such as removing disallowed terms or truncating text beyond a configured length. The server produces a sanitized response sentence string as output, ensuring valid text encoding and compliance with display constraints.

### Step 14:

The server performs format conversion processing on the sanitized response sentence string using product attribute information as input. The server scans the response sentence for placeholders such as “{product_name}” and “{battery_capacity}”, and replaces them with concrete values extracted from the product information records. The server outputs a fully formatted response sentence that contains accurate and up-to-date product data.

### Step 15:

The server generates a shortened explanation sentence using the fully formatted response sentence as input. The server either applies a rule-based truncation algorithm or calls the generative AI model with an additional prompt sentence, such as:
“Summarize the following answer in two short bullet points suitable for display next to a ‘Buy’ button. Focus on the most important benefits for a general customer.”

The server outputs a concise summary text, for example two short sentences or bullet points, which is suitable for compressed display on the terminal.

### Step 16:

The server constructs a response payload using the fully formatted response sentence, the shortened explanation sentence, and product identifiers as input. The server creates a structured object that includes display text fields, summary fields, product identifiers, and flags indicating whether to show images or purchase options, as output. The server transmits this response payload to the terminal via the communication interface.

### Step 17:

The terminal receives the response payload as input. The terminal parses the payload, extracts the response sentence, the shortened explanation sentence, and product identifiers, and generates display elements such as chat bubbles, summary banners, and product cards as output. The terminal renders the virtual character avatar and displays the response text in the user interface. If text-to-speech is enabled, the terminal feeds the response sentence into a TTS component to produce audio output, and synchronizes avatar animations with the audio.

### Step 18:

The user reads or listens to the response and may perform further operations on the terminal. The terminal captures user actions such as scrolling, opening product details, clicking a “Buy” button, or sending another question as input events. The terminal labels each event with the conversation identifier, turn index, product identifier, and timestamp, and outputs structured event records. The terminal transmits these event records to the server as interaction log data.

### Step 19:

The server receives the interaction log data and any transaction completion messages from the terminal as input. The server writes each event into an interaction_log table and each completed transaction into a sales_log table as output. The server associates each event and transaction record with the corresponding dialog turn and prompt template identifier by using conversation identifier and turn index fields.

### Step 20:

The server periodically reads accumulated dialog_log, interaction_log, and sales_log records as input for analysis. The server uses data processing algorithms to group records by user identifier, by prompt template identifier, and by user segment. The server computes aggregates such as click-through rate, conversion rate, average revenue per dialog turn, and average session length as output metrics.

### Step 21:

The server applies machine learning algorithms to the aggregated metrics and user behavior features as input. The server generates user segments by clustering feature vectors and assigns each user to a segment label as output. The server also computes response quality indicators for each prompt template, such as probability of click or probability of purchase conditioned on the template. The server stores the segment labels in the user_profile table and the quality indicators in association with the prompt_template table.

### Step 22:

The server selects optimal prompt templates for each user segment using the response quality indicators as input. The server compares performance scores between prompt templates within the same segment and updates template statuses as output, marking high-performing templates as active and low-performing templates as deprecated. The server writes these changes into the prompt_template table, so that future model input construction operations will use the updated template selection.

### Step 23:

The server generates information for a management display device using the prompt_template table and the response quality indicators as input. The server constructs a dataset containing template identifiers, prompt sentence texts, target segments, and evaluation metrics as output. The server transmits this dataset to the management display device, where an administrator can visually inspect and optionally override template selections.

### Step 24:

The user (administrator) interacts with the management display device by selecting or deselecting prompt templates based on the displayed metrics.

The terminal for management transmits the selection results, including identifiers of approved or rejected templates, to the server as input. The server updates the status fields and priority values for the corresponding templates in the prompt_template table as output.

### Step 25:

The server uses the updated prompt_template table and user profile table as input to drive subsequent dialog processing cycles. When the server receives new user messages, the server selects system-level and task-level prompt sentences based on the current user segment and the latest template statuses, and constructs new model input objects as output. Through this repeated cycle, the server continuously adapts the generative AI model behavior to observed user interactions and measured performance indicators, improving computational efficiency, response accuracy, and personalization over time.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computerized customer-interaction systems, including rule-based recommendation engines and static script engines, are limited in their ability to exploit generative AI models effectively. In many existing systems, a generative AI model is merely invoked as a black-box text generator driven by ad-hoc prompts that are manually crafted or loosely coupled to underlying behavioral and transactional data. As a result, such systems do not systematically integrate real-time multimodal signals (such as image information, audio information, and emotional state), historical behavior data, and feedback data into the prompt design, and therefore fail to provide stable, reproducible improvements in sales promotion strategy, service quality, and system-level performance.

In particular, conventional architectures typically suffer from at least the following technical problems. First, the systems lack a structured mechanism for transforming heterogeneous input signals-user behavior data, transaction data, image information, audio information, and feedback information-into machine-interpretable, consistently formatted prompt sentences suitable for a generative AI model. This often causes prompt drift, unpredictable model outputs, and degraded quality of generated interaction content, which in turn increases latency due to repeated trial-and-error calls to the model and wastes computational resources.

Second, existing systems rarely log and correlate, in a machine-processable manner, the relationship between (i) prompt sentences, (ii) generated outputs from the generative AI model, and (iii) concrete interaction outcomes such as transaction result information and user evaluation information. Without such structured correlation, it is difficult for the system itself to learn which prompt patterns and interaction scenarios are effective, and to automatically update sales promotion strategies or interaction policies. Consequently, system performance tuning remains a manual and offline process, leading to sub-optimal utilization of computing resources and communication bandwidth.

Third, current systems often treat visual and auditory presentation components, such as artificial characters and information presentation interfaces, as independent front-end modules that are not tightly integrated into the data processing pipeline. The response style and expression style of these components are typically hard-coded or configured through simple parameters, and are not dynamically controlled based on user attribute information, emotional state, and aggregated performance metrics. This results in a mismatch between the generative AI model's internal reasoning and the externally rendered interaction, and prevents the system from fully exploiting the model's generative capabilities to improve user engagement and system-level metrics such as conversion rate and response latency.

Fourth, there is no closed feedback loop by which the system can use the generative AI model itself, at a meta-level, to analyze historical interaction result information and transaction result information and to redesign or optimize the very prompt sentences and strategy parameters that drive future model calls. In the absence of such a loop, the system cannot algorithmically converge toward more efficient prompt structures, interaction scenarios, or sales promotion strategies that minimize unnecessary model invocations and maximize the effectiveness of each call.

Accordingly, there is a need for a computer-implemented system and server architecture that: (i) systematically collects and normalizes multimodal user data; (ii) automatically constructs prompt sentences that encode user attribute information, emotional state, interest degree, and presentation profile information; (iii) correlates prompts, model outputs, and objective outcome metrics in a structured storage; and (iv) uses the generative AI model itself, via meta-level prompt sentences, to continuously update prompt templates and strategy parameters. Such a system would improve the functioning of the computer system as a whole by reducing redundant processing, stabilizing the quality of generated outputs, and enabling data-driven, automatic optimization of interaction flows and sales promotion strategies.

The specific processing by the specific processing unit 290 of the data processing device 12 in Application Example 2 is realized by the following means.

The present invention provides a server comprising at least one processor and at least one memory storing instructions that, when executed by the processor, cause the processor to perform operations including: accessing behavior data and transaction data related to a user stored in a storage unit; receiving, from an acquisition unit, image information and audio information related to the user; analyzing the image information and the audio information to estimate an emotional state of the user and a degree of interest of the user; analyzing the behavior data and the transaction data to generate attribute information of the user; generating a first prompt sentence based on at least the attribute information, the emotional state, the degree of interest, and situation information related to an interaction with the user, the first prompt sentence being configured as input to a generative AI model; transmitting the first prompt sentence to the generative AI model and receiving from the generative AI model a generation result including response content for the user and a sales promotion policy; controlling at least one of an artificial character and an information presentation interface so as to perform voice output and visual output to the user based on the generation result, thereby executing individualized interaction for the user; collecting interaction result information and transaction result information related to the individualized interaction and storing the interaction result information, the transaction result information, and the first prompt sentence in association with one another in the storage unit; generating a meta-level second prompt sentence that instructs the generative AI model to analyze at least the stored interaction result information and the stored transaction result information, transmitting the meta-level second prompt sentence to the generative AI model, receiving an analysis result from the generative AI model, and updating at least one of the sales promotion policy and a configuration of the first prompt sentence based on the analysis result; and collecting evaluation information and opinion information from the user as feedback, generating a third prompt sentence that instructs the generative AI model to analyze the feedback, transmitting the third prompt sentence to the generative AI model, receiving an analysis result for the feedback, and improving at least one of the individualized interaction and behavior parameters of the artificial character based on the analysis result for the feedback. This enables the computer system to automatically transform heterogeneous multimodal user data into structured prompt sentences, to tightly couple generative AI outputs with concrete presentation control, and to implement a closed optimization loop in which the generative AI model itself is used at a meta-level to refine prompt templates and strategy parameters, thereby improving overall computational efficiency, stability of generated interaction content, and effectiveness of system-driven sales promotion and service quality.

The term “processor” refers to a hardware computation element, such as a central processing unit or a processing core, that executes machine-readable instructions to perform logical operations, arithmetic operations, control operations, and data transfer operations within the system.

The term “storage unit” refers to a hardware data retention component, such as a memory device or a storage device, that is configured to store behavior data, transaction data, prompt sentences, generation results, and other information used or produced by the system.

The term “acquisition unit” refers to a hardware and/or software component, such as a sensor interface or an input interface, that is configured to acquire image information and audio information related to a user and to provide the acquired information to the processor.

The term “behavior data” refers to data indicating actions, operations, or usage patterns of a user in relation to a service or environment, including but not limited to browsing logs, movement logs, interaction histories, and operation histories.

The term “transaction data” refers to data indicating commercial or service-related outcomes associated with a user, including but not limited to purchase records, subscription records, contract changes, and payment histories.

The term “image information” refers to digital data representing still images or moving images obtained from an imaging device, such as a camera, and including facial images or body images of a user.

The term “audio information” refers to digital data representing sound, including voice of a user, background sound, or conversation audio, captured by a sound collection device, such as a microphone.

The term “emotional state” refers to an internal affective condition of a user, such as joy, sadness, confusion, anger, or calmness, which is estimated by analyzing at least one of the image information and the audio information.

The term “degree of interest” refers to a quantitative or qualitative measure indicating how strongly a user is interested in an object, service, or content, as estimated from behavior data, image information, audio information, or a combination thereof.

The term “attribute information” refers to information derived from behavior data and transaction data that characterizes a user, including but not limited to preference categories, spending tendencies, usage frequency, and demographic classifications.

The term “situation information” refers to contextual information related to an ongoing interaction with a user, including at least one of time, place, interaction stage, currently presented item, and current interaction channel.

The term “prompt sentence” refers to a machine-interpretable natural language or structured instruction string that is generated by the processor and provided as input to a generative AI model in order to cause the generative AI model to perform a specific generation or analysis task.

The term “generative AI model” refers to a machine learning model configured to generate data, such as text, based on an input prompt sentence, and including, for example, a neural network-based language model or a similar generative model.

The term “generation result” refers to output information produced by the generative AI model in response to a prompt sentence, including at least response content, explanatory content, or a sales promotion policy.

The term “response content” refers to interaction information, such as dialog sentences or guidance text, that is generated by the generative AI model and is intended to be presented to a user through voice output or visual output.

The term “sales promotion policy” refers to data indicating one or more strategies, rules, or guidelines for promoting products or services to a user, which are at least partially derived from the generation result of the generative AI model.

The term “artificial character” refers to a virtual representation, such as a graphical character or avatar, that is controlled by the processor and that presents information to a user through at least one of visual output and voice output.

The term “information presentation interface” refers to a user-facing output interface, such as a display device, a graphical user interface, or a mixed-reality output device, that visually and/or auditorily presents information generated by the system.

The term “individualized interaction” refers to interaction behavior that is controlled by the processor and is adapted to a specific user based on at least attribute information, emotional state, degree of interest, or feedback information related to the user.

The term “interaction result information” refers to data indicating the outcome, progression, or characteristics of an interaction with a user, including but not limited to interaction duration, content presented, user responses, and interaction success indicators.

The term “transaction result information” refers to data indicating results of commercial or service transactions following or associated with an interaction, including purchase occurrences, selected options, or conversion outcomes.

The term “meta-level prompt sentence” refers to a prompt sentence that instructs the generative AI model to analyze stored data such as interaction result information, transaction result information, or prompt logs, and to output analysis or optimization information for improving subsequent prompt sentences or strategies.

The term “analysis result” refers to information obtained from the generative AI model in response to a meta-level prompt sentence, including but not limited to patterns, correlations, recommendations, or parameter adjustments.

The term “display profile information” refers to information defining at least one of appearance attributes and speaking style attributes of an artificial character or information presentation interface, including tone, formality, visual style, and persona characteristics.

The term “response style” refers to characteristics of generated response content, including formality level, politeness level, tone, and structural style, that are adapted to match display profile information or interaction context.

The term “expression style” refers to characteristics of how content is visually or aurally presented to a user, including choice of gestures, facial expressions, timing, and emphasis, as controlled for an artificial character or interface.

The term “prompt template” refers to a reusable structural pattern for constructing a prompt sentence, including slots or fields for inserting attribute information, emotional state, situation information, and other variables.

The term “interaction scenario” refers to a structured sequence or pattern of interactions between the system and a user, including branching rules, timing of responses, and content types used across multiple interaction steps.

The term “sales promotion strategy parameter” refers to a configurable value used by the system to control aspects of a sales promotion policy, including thresholds, priorities, allocation ratios, and selection rules for offers or recommendations.

The term “evaluation information” refers to data representing subjective or objective assessments provided by a user regarding an interaction or service, including ratings, satisfaction scores, or explicit evaluations.

The term “opinion information” refers to free-form or structured comments, remarks, or suggestions provided by a user as feedback, which may relate to content, interface behavior, or overall service experience.

The term “feedback” refers to a combination of evaluation information and opinion information obtained from a user after or during an interaction, and used by the system to refine individualized interaction and system behavior.

The term “behavior parameters of the artificial character” refers to adjustable values that control behavior of an artificial character, including talking speed, gesture frequency, facial expression intensity, and level of proactiveness, as set or updated by the processor.

In one embodiment, a server, a terminal, and a user cooperate to implement a system that generates, executes, and optimizes prompt sentences for a generative AI model, while tightly coupling the generated outputs to multimodal sensing and presentation hardware. The system is configured so that the server performs data aggregation, analysis, prompt generation, and model invocation; the terminal performs data acquisition and user-facing presentation; and the user provides implicit and explicit feedback.

The server uses one or more hardware processors, such as multi-core central processing units and graphics processing units, and one or more storage units, such as volatile memory and non-volatile storage devices. In a typical implementation, the server uses general-purpose computing hardware (for example, x86 or ARM server processors combined with GPU accelerators) and executes software modules including an operating system, a data management module, a model-serving module, and an application logic module. The server can execute frameworks such as a numerical computation framework and a deep-learning framework to implement a generative AI model and auxiliary neural networks. The generative AI model can be a transformer-based language model including a plurality of layers, each layer including multi-head self-attention units, feed-forward networks, normalization units, and non-linear activation units. The model is trained in advance using a training dataset including natural-language sentences, and learns to generate output sentences conditioned on prompt sentences.

The terminal uses one or more input devices, such as a camera and a microphone, and one or more output devices, such as a display, loudspeakers, and a haptic interface. The terminal includes a local processor and a communication interface. In one embodiment, the terminal is realized by a mobile computing device or a dedicated kiosk, and executes client software to control the camera, the microphone, and a graphical user interface, and to transmit acquired data to the server over a communication network using a communication protocol.

The user is a person who interacts with the terminal and indirectly with an artificial character or an information presentation interface controlled by the server. The user performs physical actions such as looking at a screen, speaking, selecting options, and providing feedback. The user's behavior generates behavior data, transaction data, image information, audio information, evaluation information, and opinion information that are processed by the server. The server stores behavior data and transaction data in a storage unit in a structured format. For example, the server stores behavior data in a behavior log table that has fields such as user identifier, timestamp, action type, action target, and context identifier. The server stores transaction data in a transaction table that has fields such as transaction identifier, user identifier, item identifier, quantity, monetary value, and outcome label. The server further stores attribute information, emotional state information, degree of interest information, prompt sentences, generation results, interaction result information, transaction result information, and feedback information in respective tables or data structures. Each table is indexed by a user identifier and a session identifier so that the server can efficiently correlate data across different types.

The server generates attribute information by executing data processing operations on the behavior data and the transaction data. The server performs feature extraction operations, such as counting frequencies of item categories, calculating average transaction values, and computing recency-frequency-monetary scores. The server then applies a clustering algorithm or a supervised classification algorithm, such as a gradient boosting classifier or a feed-forward neural network, to derive attribute information such as a preferred category, a price sensitivity class, and an activity level class. The server stores these results as attribute vectors associated with user identifiers.

The server estimates an emotional state and a degree of interest of the user by processing image information and audio information acquired by the terminal. The server uses a convolutional neural network to analyze face images and to output probability scores for a set of emotion labels, such as happiness, sadness, confusion, anger, neutrality, and excitement. The convolutional neural network includes convolution layers, pooling layers, and fully connected layers, and is trained using a dataset of labeled facial images. The server uses an audio feature extractor to compute acoustic features such as mel-frequency cepstral coefficients, pitch, intensity, and spectral features, and feeds these into a recurrent neural network or another classifier to compute emotion-related scores for the audio signal. The server combines the visual and audio scores using a fusion algorithm, for example, a weighted average or a small feed-forward network, to estimate a unified emotional state and a degree of interest. Because the server uses separate learned models for visual and audio signals and then fuses them at a feature level, the server can achieve higher emotion-estimation accuracy and robustness to noise compared with a system relying only on a single modality.

The server generates prompt sentences by combining attribute information, emotional state information, degree of interest information, and situation information. The server uses a prompt template that is a text pattern with placeholders. For example, the server uses a template such as:
“Customer profile: [ATTRIBUTE_SUMMARY].
Current behavior: [BEHAVIOR_SUMMARY].
Current emotion: [EMOTION_SUMMARY].
Task: As a helpful assistant, generate a concise response for this situation.”

The server fills the placeholders with concrete values derived from the stored data. In one example, the server generates a prompt sentence as follows:
“Customer profile: age group 30s, mainly buys skincare, medium price sensitivity, visits store weekly.
Current behavior: the customer is smiling but looks slightly confused while holding ‘premium moisture serum’.
Current emotion: main emotion=joy, secondary emotion=slight confusion.
Task: As a friendly in-store assistant, generate a concise sales talk that reassures the customer about the price and emphasizes long-term skin benefits and safety of this product. Respond in under 80 words.”

The server transmits the prompt sentence to the generative AI model, either running on the same hardware or on another computing node, and receives a generation result. The generation result includes response content, such as natural-language sentences to be spoken by the artificial character, and may also include a sales promotion policy, such as which product attributes to emphasize, whether to propose an upsell, and how to structure the conversation. The server parses the generation result to identify sections corresponding to a greeting, an explanation, and a recommendation, and stores the generation result together with the prompt sentence in the storage unit.

The server controls an artificial character or an information presentation interface based on the generation result. The server transmits the response content to the terminal along with control parameters such as speaking style, expression style, and timing cues. The terminal converts the response content into speech using a text-to-speech engine and renders the artificial character on the display. The terminal modulates facial expressions, gestures, and timing in accordance with the control parameters, for example, by mapping emphasis markers to facial expression intensity. This mapping is not a generic automation of human work but a specific machine-level control scheme that synchronizes neural-network-generated content with low-level rendering parameters. As a result, the system reduces jitter between textual content and visual behavior, thereby improving user comprehension and reducing the need for repeated explanations, which in turn reduces bandwidth consumption and server load. The server collects interaction result information and transaction result information during and after the individualized interaction. The terminal reports user actions such as button selections, dwell time, and spoken replies. The server stores these in an interaction log table with fields for interaction step identifiers and outcome labels. The server also records whether a transaction was completed, whether an offer was accepted, and how much time elapsed between initial contact and conversion. By storing prompt sentences, generation results, and outcome metrics in a correlated fashion, the server creates a data structure that allows efficient analysis of which prompt templates and output patterns perform well.

The server generates meta-level prompt sentences by summarizing logged data. For example, the server constructs a meta-level prompt sentence such as:
“Here are aggregated results of 10,000 sessions, including prompt texts, emotional states, and conversion metrics. Analyze which prompt patterns and emotion combinations most improved conversion and satisfaction, and propose five new prompt templates to test.”

The server inputs this meta-level prompt sentence to the generative AI model. The generative AI model, which has been trained on diverse text data and is now conditioned on the analysis instruction, outputs candidate prompt templates and strategy suggestions. The server does not merely accept these suggestions blindly. The server further applies rule filters and validation algorithms to ensure that the proposed templates are syntactically valid and compatible with the system's data fields. The server then updates its prompt templates for future interactions. Because the server uses the generative AI model itself to restructure prompt templates based on correlated logs, the system can automatically improve the quality and stability of subsequent model invocations. This closed loop results in fewer failed interactions and reduces the number of retries needed to obtain high-quality outputs, thereby reducing processing time and communication overhead.

The server also collects evaluation information and opinion information from the user as feedback. The terminal displays a survey question such as “How satisfied were you with this interaction?” or “Please describe anything that was confusing.” The user enters a rating or free-form comments, and the terminal transmits them to the server. The server generates a third prompt sentence configured to instruct the generative AI model to analyze this feedback in conjunction with existing logs. An example prompt sentence is:
“Based on the following user feedback comments and satisfaction scores, explain common causes of dissatisfaction and propose concrete changes to the assistant's tone and explanation style.”

The server transmits this prompt sentence and receives an analysis output suggesting adjustments to behavior parameters of the artificial character, such as reducing speaking speed or adding clarifying statements before technical terms. The server converts these suggestions into updated parameter values, storing them as behavior parameters associated with a display profile. On subsequent interactions, the server references these updated parameters when generating prompt sentences and when sending control information to the terminal, thus effecting a measurable change in presentation that reflects system-internal optimization rather than manual configuration.

The server improves computer technology itself in several ways. First, the server uses a structured data representation that explicitly links prompt sentences, model outputs, and objective outcomes, which enables efficient retrieval and analysis. This reduces the need for broad, unstructured log scanning and lowers the computational cost of optimization routines. Second, by synthesizing multimodal features (behavior, transaction, visual, and audio features) into a compact attribute and emotion representation, the server significantly reduces the dimensionality of the input to the generative AI model. This leads to shorter prompt sentences and reduces the average length of tokens processed by the generative AI model, which in turn lowers inference latency and consumption of computational resources.

Third, the server employs a non-conventional workflow in which the generative AI model is not only used for direct dialog generation but also used at a meta-level to update prompt templates and strategy parameters. This dual use of the same model introduces a feedback mechanism that can converge to stable, high-performing configurations. In contrast, a conventional system that uses a generative AI model only for direct outputs would require manual tuning or separate optimization algorithms, resulting in higher human effort and slower adaptation. The claimed architecture integrates optimization into the same generative framework and structures the data so that the process can run automatically.

Fourth, the server realizes improved data management by storing data in a normalized schema with explicit foreign-key relationships between user identifiers, sessions, prompts, outputs, and outcomes. This structure allows the server to perform indexed queries and incremental updates, reducing input/output load and enabling scalability across large numbers of users. By aligning the data schema with the requirements of both real-time interaction and offline optimization, the system provides better throughput and lower response times.

In other embodiments, the server can support multiple generative AI models specialized for different tasks. For example, the server may use a large transformer-based language model for natural-language generation, a smaller transformer or recurrent model for emotion classification, and another model for summarization of interaction logs. The server may route different prompt sentences to different models based on their content type and explicit tags. This modularization allows the server to allocate computing resources more efficiently and to avoid sending large volumes of raw data to a single-purpose model.

The terminal can take various forms. In one embodiment, the terminal is a head-mounted display that overlays the artificial character on a physical environment using augmented reality. In another embodiment, the terminal is a touchscreen kiosk that displays the artificial character on a two-dimensional display. In all cases, the terminal executes consistent client logic that receives high-level control instructions from the server and maps them to low-level rendering commands. For example, when the server sets a “calm and polite” response style in the prompt sentence, the terminal interprets that as a set of rendering parameters, such as low gesture frequency and moderate facial expression intensity, thus demonstrating that semantic attributes computed in the server are converted into technical control values in the terminal. The user may interact with different terminals at different times, and the server uses the stored attribute information and feedback information to maintain continuity. For example, if the user previously indicated a preference for short explanations, the server will embed a constraint such as “Respond in under 50 words” into future prompt sentences and adjust the behavior parameters to favor concise speech. This behavior is not a generic business rule; rather, it is a machine-level adaptation that changes the length and structure of prompts and hence changes the internal token flow within the generative AI model. As a result, the model's inference path is altered, which can reduce processing time and memory consumption.

Alternative embodiments can include different learning methods for the underlying neural networks. The server may train the facial expression model using supervised learning with a cross-entropy loss function and update weights using stochastic gradient descent or an adaptive optimization algorithm. The server may train the audio emotion classifier using sequence data and a loss function that penalizes misclassification of negative emotions more strongly than positive emotions to reduce false negatives in critical situations. The server may also apply data augmentation techniques such as horizontal flipping, noise injection, and time-stretching to improve robustness. These technical training details enable the server to obtain more accurate and stable emotion estimations, thereby improving the reliability of the attribute-emotion-based prompt generation pipeline.

In summary, the server, the terminal, and the user implement multiple embodiments in which the server transforms heterogeneous input data into structured prompt sentences, invokes a generative AI model to obtain generation results, and uses meta-level prompt analysis to automatically refine prompt templates and strategy parameters. The terminal converts the generation results into concrete audiovisual outputs, and the user provides feedback that is re-ingested into the optimization cycle. Because the system integrates model structure, data structure, and control logic in a unified architecture, the system achieves technical effects including improved data management, reduced inference latency, enhanced accuracy of emotion estimation and content personalization, and autonomous optimization of interaction flows that cannot be easily realized by manual or purely rule-based systems.

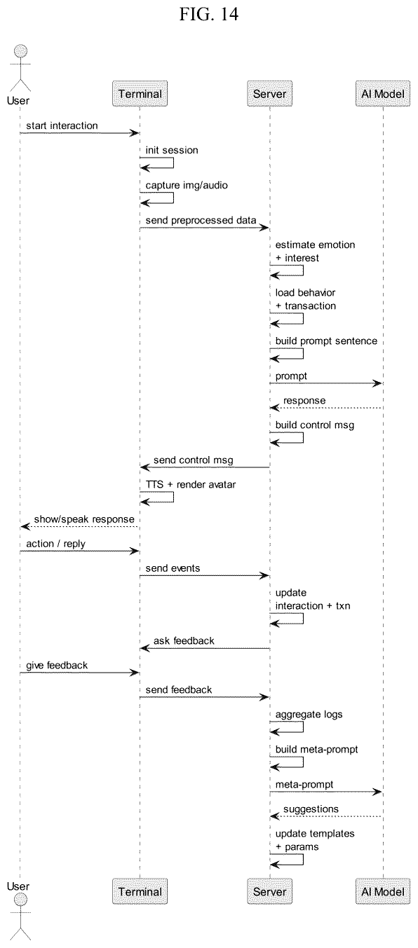

The following describes the processing flow using FIG. 14.

### Step 1:

The terminal initializes sensing and communication components.

The terminal activates a camera, a microphone, and a network interface, and assigns a temporary session identifier to a new interaction.

Input: a trigger event indicating that the user has started an interaction (for example, proximity detection, screen touch, or application start).

Output: an active session context containing a session identifier and hardware handles for the camera, microphone, and network sockets.

The terminal allocates buffers for image frames and audio samples and configures frame rate, resolution, sampling rate, and compression parameters.

### Step 2:

The terminal acquires raw image information and audio information from the user.

The terminal captures a sequence of face images from the camera and raw audio samples from the microphone while the user is in front of the device and speaking or performing actions. Input: sensor signals from the camera and the microphone under the active session context.

Output: raw image data (for example, RGB frames) and raw audio data (for example, PCM samples) associated with the session identifier.

The terminal time-stamps each frame and audio segment and stores them temporarily in a local buffer for preprocessing.

### Step 3:

The terminal preprocesses the image information and audio information.

The terminal downsamples and crops face regions in the image frames, normalizes pixel values, and encodes frames into a compact format; the terminal also segments the audio stream into fixed-length windows, computes acoustic features such as energy and spectral shape, and, if needed, compresses the audio.

Input: raw image data and raw audio data from Step 2.

Output: preprocessed image data (for example, resized face crops) and preprocessed audio features (for example, feature vectors or encoded segments) bundled into a session payload. The terminal packages the preprocessed data with the session identifier into a message and transmits the payload to the server via a secure communication channel.

### Step 4:

The server receives and stores the multimodal session payload.

The server accepts the message from the terminal through a network endpoint and validates the session identifier and data format.

Input: the preprocessed image data and audio features, along with session metadata, from Step 3.

Output: a stored session record in a storage unit containing image features, audio features, and references to the originating terminal.

The server parses the payload, checks integrity (for example, size and checksum), and writes references to internal buffers or database tables so that subsequent processing modules can access the data efficiently.

### Step 5:

The server estimates the emotional state and degree of interest of the user.

The server applies a trained image analysis network to the face images to produce emotion probabilities and applies an audio classifier to the audio features to produce vocal emotion and engagement scores; the server then fuses both results to obtain a unified emotional state and degree of interest.

Input: preprocessed image data and preprocessed audio features retrieved from the stored session record in Step 4.

Output: an emotional state label (for example, “joy”, “confusion”) and a degree of interest value (for example, a numeric score), which are added to the session record.

The server executes numerical operations such as convolution, pooling, matrix multiplications, and non-linear activation in the neural networks, and performs a fusion operation (for example, weighted averaging or a small feed-forward network) on the resulting logits to derive the final emotional indicators.

### Step 6:

The server retrieves behavior data and transaction data and generates attribute information. The server queries one or more data tables containing past user actions and transactions and aggregates them into a compact representation of user preferences and patterns.

Input: a user identifier or a session identifier associated with stored behavior data and transaction data.

Output: attribute information including, for example, preferred categories, spending range, usage frequency, and responsiveness to prior offers, stored as an attribute vector linked to the session.

The server executes data operations such as filtering by user identifier, grouping by item category, computing counts and averages, and optionally applying a classification or clustering algorithm to map continuous metrics into discrete attribute classes.

### Step 7:

The server constructs a prompt sentence for the generative AI model.

The server combines the attribute information from Step 6, the emotional state and degree of interest from Step 5, and situation information such as the current item or interaction stage, and formats these into a natural-language prompt sentence following a predefined template. Input: attribute information, emotional state, degree of interest, and situation information associated with the session.

Output: a structured prompt sentence text that fully specifies the context and the requested task to be performed by the generative AI model.

The server inserts textual representations of attributes and emotions into placeholder positions, for example generating:
“Customer profile: age group 30s, mainly buys skincare, medium price sensitivity, visits store weekly.
Current behavior: the customer is smiling but looks slightly confused while holding ‘premium moisture serum’.
Current emotion: main emotion=joy, secondary emotion=slight confusion.
Task: As a friendly in-store assistant, generate a concise sales talk that reassures the customer about the price and emphasizes long-term skin benefits and safety of this product. Respond in under 80 words.”

### Step 8:

The server transmits the prompt sentence to the generative AI model and receives a generation result.

The server sends the prompt sentence as input to a transformer-based language model running locally or on a remote computing node and executes inference to generate response content and policy hints.

Input: the prompt sentence generated in Step 7.

Output: a generation result comprising response content (for example, one or more sentences of dialog) and optional structured hints (for example, recommended tone or level of detail) associated with the session.

The server tokenizes the prompt sentence, feeds the tokens into the model, performs attention and feed-forward computations across model layers, decodes the output tokens into text, and may parse simple tags indicating suggested behavior (for example, “calm_tone” or “offer_cross_sell”).

### Step 9:

The server prepares control instructions for the artificial character or information presentation interface.

The server converts the generation result into a format that specifies what should be displayed or spoken and how it should be presented by the terminal.

Input: response content and optional policy hints from the generation result in Step 8.

Output: a control message including dialog text, presentation style parameters, and timing information for the terminal.

The server attaches attributes such as voice style, speaking speed, facial expression intensity, and gesture preferences to the response content, based on both the policy hints and stored display profile information, and serializes these into a control structure sent to the terminal.

### Step 10:

The terminal renders the individualized interaction to the user.

The terminal receives the control message and uses local rendering components to present the content through an artificial character or an information presentation interface.

Input: the dialog text and presentation style parameters from Step 9.

Output: audiovisual output perceived by the user, including spoken dialog and corresponding visual animation or display.

The terminal calls a text-to-speech engine using the dialog text and selected voice style to synthesize audio, synchronizes mouth movements and facial expressions of the artificial character with the audio, and displays associated textual or graphical elements on the screen.

### Step 11:

The user interacts with the terminal and performs actions or provides responses.

The user listens to or reads the presented content, speaks answers, selects options, or navigates the interface, thereby generating new behavior data and possibly transaction data. Input: audiovisual content and interface controls presented in Step 10.

Output: user actions such as speech segments, button presses, item selections, or purchase confirmations, observable by the terminal.

The user may, for example, say “Yes, I would like to buy this product,” or tap a purchase button, thereby triggering subsequent processing.

### Step 12:

The terminal captures follow-up behavior and interaction results.

The terminal detects user speech and interface actions and records them as new events tied to the session identifier.

Input: user actions and signals from Step 11.

Output: updated behavior data (for example, acceptance or rejection of a recommendation, time spent on a screen) and preliminary interaction result indicators (for example, “offer_accepted” flag), which are packaged for transmission to the server.

The terminal encodes these events in a compact representation, such as event codes and timestamps, and sends them to the server along with any updated audio or image segments that may be useful for refining emotional state estimates.

### Step 13:

The server updates interaction result information and transaction result information.

The server receives the follow-up events and, if applicable, updates or creates transaction records and computes summary indicators for the session.

Input: updated behavior data and event records from Step 12.

Output: complete interaction result information and transaction result information stored in the storage unit and linked to the corresponding prompt sentence and generation result.

The server records, for example, whether a purchase was completed, the total duration of the interaction, and the number of dialog turns, and tags the associated prompt sentence and generation result with outcome labels such as “converted” or “not_converted.”

### Step 14:

The server collects explicit feedback from the user.

The server instructs the terminal to display or speak a feedback request, and the server receives ratings or comments entered or spoken by the user.

Input: feedback responses provided by the user through the terminal, such as satisfaction scores or free-form text.

Output: evaluation information and opinion information stored as feedback records associated with the session and the original generation result.

The server structures this feedback into fields such as numerical rating, sentiment, and key phrases, optionally applying text analysis to extract topics from free-form comments.

### Step 15:

The server generates a meta-level prompt sentence for analysis and optimization.

The server aggregates prompt sentences, generation results, interaction results, transaction results, and feedback across multiple sessions and formats a summary into a higher-level prompt instructing the generative AI model to analyze patterns and propose improvements. Input: a collection of stored prompt sentences, generation results, interaction result information, transaction result information, and feedback information for many sessions. Output: a meta-level prompt sentence that specifies which metrics and relationships should be analyzed by the generative AI model.

The server may formulate, for instance:
“Here are summary statistics of past interactions, including prompt texts, emotional states, conversion outcomes, and satisfaction scores. Identify prompt patterns and response styles that correlate with high conversion and high satisfaction, and propose specific changes to prompt templates and assistant tone.”

### Step 16:

The server transmits the meta-level prompt sentence to the generative AI model and receives optimization suggestions.

The server calls the generative AI model with the meta-level prompt and requests analytical and prescriptive output.

Input: the meta-level prompt sentence from Step 15.

Output: optimization suggestions including improved prompt template structures, recommended response styles, and possible parameter adjustments for the artificial character. The server parses the output to extract candidate templates, style guidelines, and rule suggestions, and validates them for syntactic correctness and compatibility with existing data fields.

### Step 17:

The server updates prompt templates and behavior parameters based on the optimization suggestions.

The server applies accepted changes to stored prompt templates and to behavior parameters used to control the artificial character and the information presentation interface.

Input: validated optimization suggestions from Step 16.

Output: updated prompt templates and updated behavior parameter sets stored in the storage unit and referenced by future interactions.

The server modifies template text, adjusts constraints such as maximum response length or required structure, and updates default tone and style tags, thereby altering how future prompt sentences are generated and how future responses are presented on the terminal.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

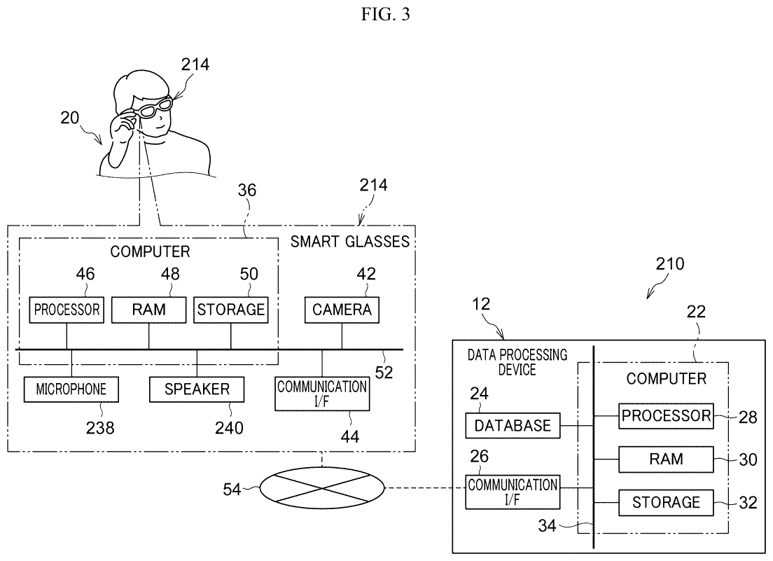

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

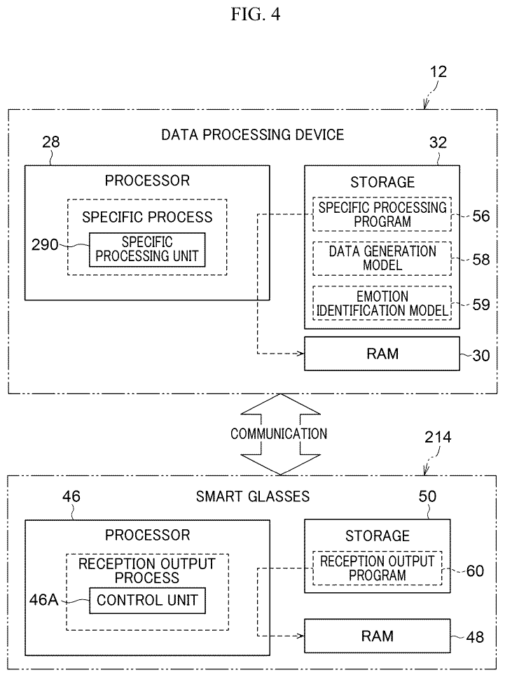

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

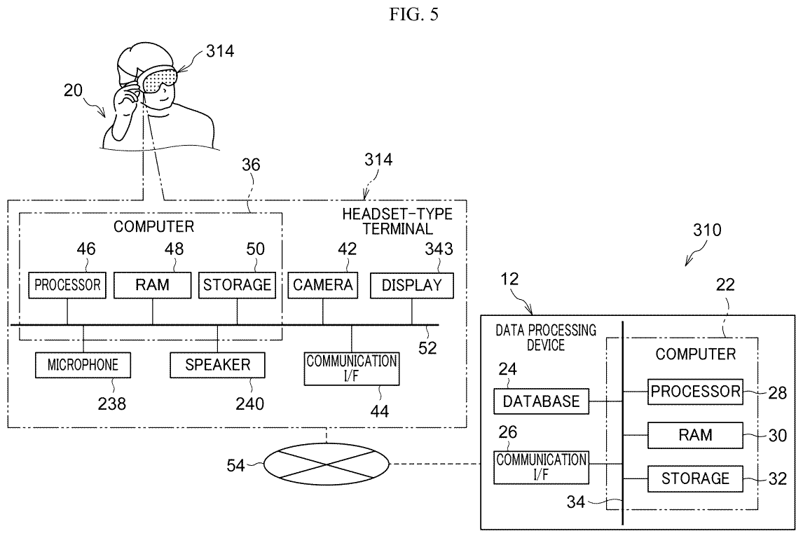

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

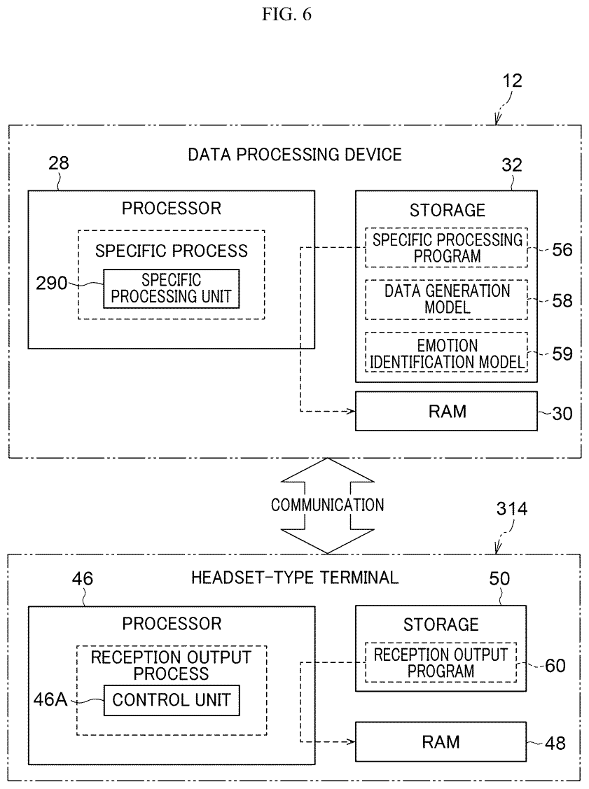

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

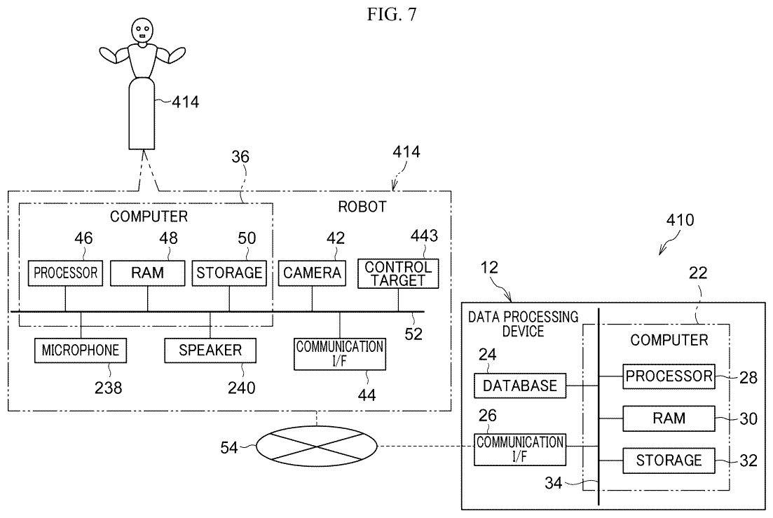

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

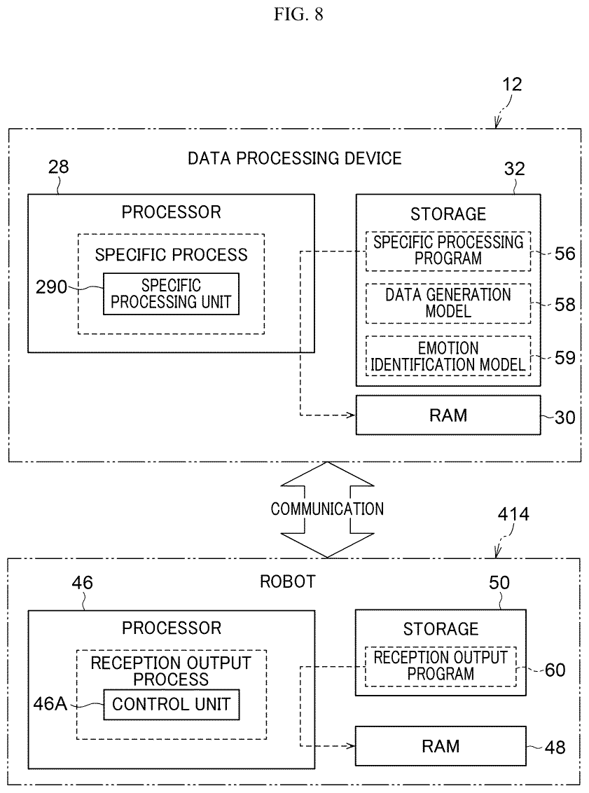

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

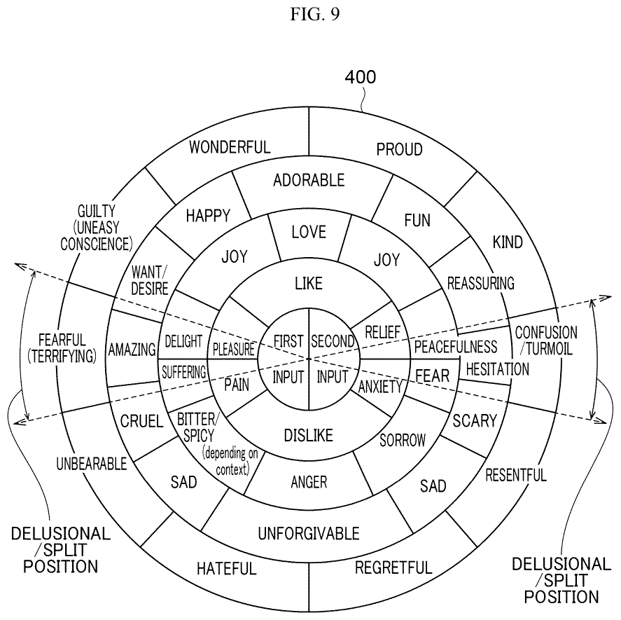

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

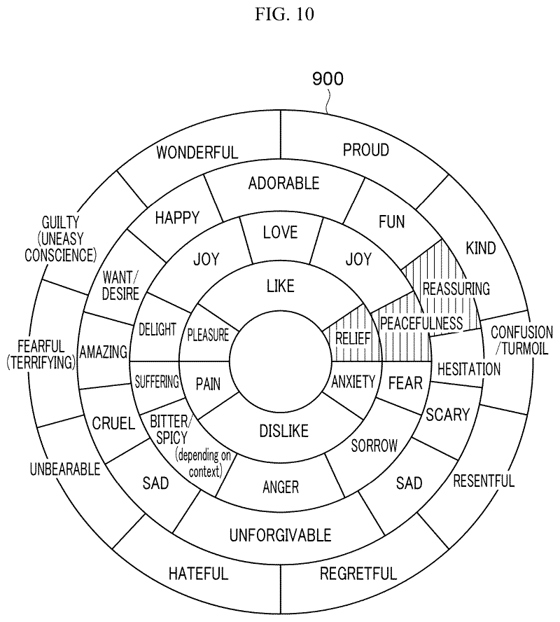

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
obtain, based on user identification information, purchase history information and behavior history information stored in a storage device, analyze the purchase history information and the behavior history information by statistical processing and feature extraction processing to generate user attribute information, and generate a prompt sentence including the user attribute information and input the prompt sentence to a generative artificial intelligence model,
obtain, from the generative artificial intelligence model, response information generated in accordance with the prompt sentence, structure the response information as customer-service content of a virtual interactive agent, combine the customer-service content with display control information including appearance information and audio information of the virtual interactive agent, and transmit the display control information to a terminal device,
store user input information obtained from the terminal device and interaction history information of the virtual interactive agent, evaluate interaction quality and sales performance of the virtual interactive agent based on the interaction history information and sales result information, generate a prompt sentence including an evaluation result and input the prompt sentence to the generative artificial intelligence model, and update a sales promotion strategy and the customer-service content of the virtual interactive agent based on output information obtained from the generative artificial intelligence model,
generate a prompt sentence that inputs feedback information of a user, obtained from the terminal device, to the generative artificial intelligence model, and change, based on an analysis result obtained from the generative artificial intelligence model, the appearance information, the audio information, and a dialogue policy of the virtual interactive agent to improve a service content,
respond, in accordance with user input information including a change request of the virtual interactive agent obtained from the terminal device, by inputting a prompt sentence including the user attribute information and the change request to the generative artificial intelligence model, dynamically reconstruct a persona, a speaker characteristic, and dialogue text of the virtual interactive agent based on output information obtained from the generative artificial intelligence model, and transmit reconstructed display control information to the terminal device, and
generate, for the prompt sentence to be input to the generative artificial intelligence model, control information specifying a plurality of output formats including dialogue text, recommended product information, and emotional expression information, by combining the user attribute information, the interaction history information, the sales result information, and the feedback information of the user.

### Supplementary 2

The system according to supplementary 1,
wherein the processor is configured to
convert voice input information obtained from the terminal device into character information by speech recognition processing, generate, based on the character information and the user attribute information, a prompt sentence for question-and-answer processing to be input to the generative artificial intelligence model, and provide response information obtained from the generative artificial intelligence model to the terminal device as utterance content of the virtual interactive agent.

### Supplementary 3

The system according to supplementary 1,
wherein the processor is configured to
create a prompt sentence that instructs the generative artificial intelligence model to generate an improvement plan of a dialogue script or an improvement plan of a sales promotion measure, using evaluation information obtained by aggregating the interaction history information of the virtual interactive agent, the sales result information, and the feedback information of the user, and update, based on an improvement plan obtained from the generative artificial intelligence model, a template of the prompt sentence, the persona of the virtual interactive agent, and a recommendation policy, thereby continuously optimizing a usage mode of the generative artificial intelligence model and the sales promotion strategy.

### Application Example 1

### Supplementary 1

A system comprising a processor,
wherein the processor is configured to
acquire, from a terminal, user-related information including purchase history information and behavior history information of a user, aggregate the user-related information by using a data analysis program and a data analysis library, and identify attribute information and user segment information related to the user,
generate, on the basis of the attribute information, the user segment information, display style information and voice output style information related to a virtual character, and a current behavior state of the user, a prompt sentence that instructs generation of product proposal information and sales promotion information for the user, and input the prompt sentence to a generative AI model to cause the generative AI model to generate a response text including the product proposal information and the sales promotion information,
transmit the response text to the terminal, cause the terminal to present the response text in a dialogue format via a display interface and a speech synthesis function of the virtual character, acquire, from the terminal, customization information including appearance setting information and voice setting information of the virtual character, store the customization information in a storage unit, and reflect the customization information in a writing style and an expression style of a subsequently generated prompt sentence and response text, and record operation history information and purchase result information of the user, acquired from the terminal after presentation of the product proposal information and the sales promotion information, in association with the prompt sentence and the response text, calculate a service quality index and a sales performance index on the basis of the record, and update generation rules and template information of the prompt sentence according to the indexes, thereby sequentially optimizing the prompt sentence to be input to the generative AI model and contents of the product proposal information and the sales promotion information.

### Supplementary 2

The system according to supplementary 1,
wherein the processor is configured to
sequentially acquire, from the terminal, the user-related information and the operation history information as event information including time-series information, aggregate and process the event information to generate, as feature quantities, purchase ratio information for each product category, visit frequency information, reaction information to the sales promotion information, and dialogue duration information with the virtual character, and update the attribute information and the user segment information by using the feature quantities.

### Supplementary 3

The system according to supplementary 1,
wherein the processor is configured to
record the prompt sentence in association with the attribute information, the user segment information, the appearance setting information and the voice setting information of the virtual character, and past service quality indexes and sales performance indexes related to the product proposal information and the sales promotion information, perform comparative evaluation among a plurality of types of prompt sentence templates on the basis of the record, and automatically select or modify contents of the prompt sentence templates according to a result of the comparative evaluation, thereby continuously improving the response text output from the generative AI model.

### Example 2

### Supplementary 1

A system comprising a processor, a storage apparatus, a communication interface, and a terminal device,
wherein the processor is configured to
acquire dialog information including user attribute information and user behavior information from the terminal device via the communication interface, and store the dialog information in the storage apparatus in a structured format,
generate input data including (i) a system-level prompt sentence that defines a role, a tone, and an explanation policy of a virtual dialog entity, (ii) a task-level prompt sentence that defines response content and a sales promotion policy toward a user, and (iii) past dialog history, on the basis of the dialog information and product information, and input the input data to a generative AI model to cause the generative AI model to generate a response sentence,
perform format conversion processing on the response sentence output from the generative AI model, the format conversion processing including inserting product attribute information acquired from a product information storage apparatus into the response sentence and generating a shortened explanation sentence for display, and transmit a result of the format conversion processing to the terminal device via the communication interface,
store user operation history information and transaction result information transmitted from the terminal device in association with the dialog information, and calculate user characteristics and response quality indicators by performing statistical analysis processing or machine learning processing on the stored information,
update or select, for each user segment defined by the user characteristics, the system-level prompt sentence and the task-level prompt sentence on the basis of the calculated user characteristics and response quality indicators, and reflect the updated or selected prompt sentences in the input data for the generative AI model so as to continuously optimize a sales promotion strategy, and
present, to a management display device, candidates of the prompt sentences corresponding to the optimized sales promotion strategy and evaluation indicators of the candidates, and reflect a selection result by a manager for the candidates in generation of the input data as an update of the prompt sentences.

### Supplementary 2

The system according to supplementary 1,
wherein the processor is configured to
aggregate the dialog information and the transaction result information, classify the user characteristics into user segments by performing user segmentation processing, and control the input data such that different groups of prompt sentences are applied to the generative AI model for the respective user segments.

### Supplementary 3

The system according to supplementary 1,
wherein the processor is configured to
associate response results of the virtual dialog entity with subsequent user operation history information, calculate evaluation indicators on the basis of the association, and, based on comparison and verification results obtained from differences in the evaluation indicators, automatically select, from among a plurality of prompt sentences, a prompt sentence having higher response quality and higher sales performance, and input the selected prompt sentence to the generative AI model.

### Application Example 2

### Supplementary 1

A system comprising a processor, a storage unit configured to store behavior data and transaction data related to a user, and an acquisition unit configured to acquire image information and audio information related to the user,
wherein the processor is configured to
analyze the image information and the audio information to estimate an emotional state of the user and a degree of interest of the user,
analyze the behavior data and the transaction data stored in the storage unit to generate attribute information of the user,
generate a prompt sentence based on the attribute information, the emotional state, the degree of interest, and situation information related to an interaction with the user, the prompt sentence being input to a generative AI model,
obtain a generation result including response content for the user and a sales promotion policy by calling an internal or external generative AI model using the prompt sentence,
control at least one of an artificial character and an information presentation interface so as to perform voice output and visual output to the user based on the generation result, and thereby execute individualized interaction for the user,
collect interaction result information and transaction result information related to the individualized interaction, and store the interaction result information, the transaction result information, and the prompt sentence in association with one another in the storage unit, generate a meta-level prompt sentence that instructs the generative AI model to analyze the stored interaction result information and the stored transaction result information, input the meta-level prompt sentence to the generative AI model to obtain an analysis result, and
update at least one of the sales promotion policy and a configuration of the prompt sentence based on the analysis result, and
collect evaluation information and opinion information from the user as feedback, generate a prompt sentence that instructs the generative AI model to analyze the feedback, input the prompt sentence to the generative AI model, and improve at least one of the individualized interaction and behavior parameters of the artificial character based on an analysis result for the feedback.

### Supplementary 2

The system according to supplementary 1,
wherein the processor is configured to
refer to display profile information indicating at least one of appearance attributes and speaking style attributes of the artificial character or the information presentation interface, and generate the prompt sentence so as to specify a response style and an expression style that conform to the display profile information, and input the prompt sentence to the generative AI model.

### Supplementary 3

The system according to supplementary 1,
wherein the processor is configured to
aggregate a plurality of prompt sentences, generation results corresponding to the plurality of prompt sentences, and the transaction result information stored in the storage unit to generate analysis data,
generate a prompt sentence that instructs the generative AI model to estimate at least one of an optimal pattern of the prompt sentence and a candidate of an interaction scenario based on the analysis data, input the prompt sentence to the generative AI model to obtain an estimation result, and automatically update at least one of a prompt template used to generate the prompt sentence and a sales promotion strategy parameter based on the estimation result.

What is claimed is:

1. A system comprising:
circuitry configured to:
retrieve, from a storage area, interaction records and behavioral log data associated with a user identifier, and apply statistical processing and feature extraction processing to the interaction records and the behavioral log data to generate user attribute information;
construct a first prompt sentence including the user attribute information and transmit the first prompt sentence via a communication interface coupled to a packet-switched network to a generative language model, and receive, from the generative language model, first response information;
structure the first response information as content data for an interactive agent entity, combine the content data with display control data including visual rendering parameters and audio rendering parameters for the interactive agent entity, and transmit the display control data as one or more data packets to a terminal device via the communication interface;
store, in the storage area, user input data received from the terminal device and session history data of the interactive agent entity, compute quality indicators and performance indicators based on the session history data, generate a second prompt sentence including the quality indicators and the performance indicators, transmit the second prompt sentence to the generative language model, and update at least one of a strategy parameter and the content data based on second response information received from the generative language model; and
acquire feedback data from the terminal device, generate a third prompt sentence that instructs the generative language model to analyze the feedback data, transmit the third prompt sentence to the generative language model, and modify at least one of the visual rendering parameters, the audio rendering parameters, and a dialogue policy of the interactive agent entity based on third response information received from the generative language model.

2. The system according to claim 1, wherein the circuitry is configured to packetize the display control data into a plurality of transport-layer data packets formatted for transmission over the packet-switched network to a registered network address of the terminal device.

3. The system according to claim 1, wherein the circuitry is configured to receive, from the terminal device, a modification request specifying a change to at least one of appearance attributes and voice attributes of the interactive agent entity, construct a prompt sentence including the user attribute information and the modification request, transmit the prompt sentence to the generative language model, and dynamically reconstruct a persona, a speaker characteristic, and dialogue text of the interactive agent entity based on response information received from the generative language model.

4. The system according to claim 3, wherein the circuitry is configured to transmit reconstructed display control data including updated visual rendering parameters and updated audio rendering parameters to the terminal device as a notification data packet via the communication interface.

5. The system according to claim 1, wherein the circuitry is configured to generate output-format control information that constrains the generative language model to produce the first response information in a structured format including a dialogue-text segment, a recommended-item segment, and an expression-control segment, and include the output-format control information in the first prompt sentence.

6. The system according to claim 1, wherein the interaction records include timestamped transaction records and the behavioral log data includes browsing event records, and wherein the feature extraction processing derives preference indicators, segment classification labels, and temporal access patterns from the interaction records and the behavioral log data.

7. The system according to claim 6, wherein the circuitry is configured to sequentially acquire updated interaction records and updated behavioral log data, compute feature quantities including a category-specific transaction ratio, a visit frequency metric, a response-rate metric for previously transmitted content data, and a session duration metric, and update the user attribute information based on the computed feature quantities.

8. The system according to claim 1, wherein the quality indicators include a response relevance score computed from the session history data and the performance indicators include a conversion metric computed from transaction result data associated with sessions of the interactive agent entity.

9. The system according to claim 1, wherein the circuitry is configured to aggregate a plurality of prompt sentences, corresponding response information received from the generative language model, and associated transaction result data to generate analysis data, construct an optimization prompt sentence that instructs the generative language model to identify an optimal prompt pattern from the analysis data, and update a prompt template stored in the storage area based on optimization response information received from the generative language model.

10. The system according to claim 1, wherein the circuitry is configured to apply an emotion identification model to at least one of audio data and image data received from the terminal device to estimate an emotional state of the user, and include the estimated emotional state in at least one of the first prompt sentence and the second prompt sentence.

11. The system according to claim 10, wherein the emotion identification model maps input data to emotion values according to an emotion map in which a plurality of emotions are arranged based on a structure giving rise to each emotion, and wherein emotions that co-occur are mapped to proximate positions in the emotion map.

12. The system according to claim 1, wherein the circuitry is configured to convert audio input data received from the terminal device into text data by speech recognition processing, construct a prompt sentence based on the text data and the user attribute information, transmit the prompt sentence to the generative language model, and provide response information received from the generative language model to the terminal device as utterance content rendered via a speech synthesis function of the interactive agent entity.

13. The system according to claim 1, wherein the circuitry is configured to generate, for each of a plurality of user segments determined from the user attribute information, a distinct system-level prompt sentence defining a role and a tone for the interactive agent entity and a distinct task-level prompt sentence defining response content and a strategy policy, and select the system-level prompt sentence and the task-level prompt sentence corresponding to a user segment of the user for inclusion in the first prompt sentence.

14. The system according to claim 13, wherein the circuitry is configured to compute segment-specific evaluation indicators based on the quality indicators and the performance indicators, compare the evaluation indicators across a plurality of candidate prompt sentences per user segment, and automatically select a candidate prompt sentence having a highest evaluation indicator for subsequent input to the generative language model.

15. The system according to claim 1, wherein the circuitry is configured to perform format conversion processing on the first response information, the format conversion processing including inserting item attribute data retrieved from a product information storage area into the first response information and generating a shortened display text for rendering on the terminal device.

16. The system according to claim 1, wherein the circuitry is configured to present, via a management interface, candidate prompt templates and associated evaluation indicators to an administrator, receive a selection input from the administrator, and update a prompt template stored in the storage area based on the selection input.

17. The system according to claim 1, wherein the circuitry is configured to encode the display control data with a display controller command that causes the terminal device to render the interactive agent entity including at least one of a visual avatar representation and an audio output stream synchronized with dialogue text.

18. A system comprising:
circuitry configured to:
acquire, via a communication interface coupled to a packet-switched network, user-related data records including behavioral event data and transaction data associated with a user, and store the user-related data records in a storage area;
apply a data analysis program to the user-related data records to identify attribute information and segment information for the user;
construct a prompt sentence based on the attribute information, the segment information, and rendering style parameters for an interactive agent entity, and transmit the prompt sentence to a generative language model to obtain a response text including proposal content;
transmit the response text as one or more data packets to a terminal device via the communication interface for presentation via the interactive agent entity;
receive, from the terminal device, customization data specifying at least one of appearance settings and voice settings for the interactive agent entity, store the customization data in the storage area, and incorporate the customization data into a writing style and an expression style of subsequently constructed prompt sentences;
record, in the storage area, operation history data and result data received from the terminal device after presentation of the proposal content, compute a quality index and a performance index from the recorded data, and update generation rules and template information for the prompt sentence based on the quality index and the performance index; and
packetize updated proposal content into one or more transport-layer data packets and transmit the one or more transport-layer data packets to a registered network address of the terminal device.

19. The system according to claim 18, wherein the circuitry is configured to aggregate the operation history data and the result data as time-series event information, compute feature quantities including a category-specific transaction ratio, a visit frequency metric, and a session duration metric from the time-series event information, and update the attribute information and the segment information based on the computed feature quantities.

20. A method performed by circuitry, the method comprising:
retrieving, from a storage area, interaction records and behavioral log data associated with a user identifier, and applying statistical processing and feature extraction processing to generate user attribute information;
constructing a first prompt sentence including the user attribute information and transmitting the first prompt sentence via a communication interface coupled to a packet-switched network to a generative language model;
receiving first response information from the generative language model, structuring the first response information as content data for an interactive agent entity, and transmitting display control data including visual rendering parameters and audio rendering parameters to a terminal device via the communication interface;
storing session history data, computing quality indicators and performance indicators, generating a second prompt sentence including the quality indicators and the performance indicators, and updating at least one of a strategy parameter and the content data based on second response information from the generative language model; and
acquiring feedback data from the terminal device, generating a third prompt sentence for the generative language model to analyze the feedback data, and modifying at least one of the visual rendering parameters, the audio rendering parameters, and a dialogue policy of the interactive agent entity based on third response information from the generative language model.
